(19) United States
(12) Patent Application Publication
(10) Pub. No.: US 2019/0172358 A1
(43) Pub. Date: Jun. 6, 2019

(54) METHODS AND SYSTEMS FOR OBSTACLE IDENTIFICATION AND AVOIDANCE

(71) Applicant: SZ DJI TECHNOLOGY CO., LTD., Shenzhen (CN)

(72) Inventors: You ZHOU, Shenzhen (CN); Zhenyu ZHU, Shenzhen (CN); Jiexi DU, Shenzhen (CN); Canlong LIN, Shenzhen (CN); Jiahang YING, Shenzhen (CN)

(21) Appl. No.: 16/261,714

(22) Filed: Jan. 30, 2019

Related U.S. Application Data
(63) Continuation of application No. PCT/CN2016/093282, filed on Aug. 4, 2016.

(51) Int. Cl. G08G 5/00; G05D 1/10; B64C 39/02; G06K 9/00

(52) U.S. Cl. CPC G08G 5/006; G05D 1/101; B64C 2201/141; B64C 39/024; G06K 9/0063; G08G 5/0069

(57) ABSTRACT

A method of controlling a movable object includes obtaining an image of a surrounding of the movable object, obtaining a plurality of depth layers based on the image; projecting a safety zone of the movable object onto at least one of the depth layers, determining whether an object is an obstacle based on a position of the object on the at least one of the depth layers relative to the projected safety zone, and adjusting a travel path of the movable object to travel around the obstacle.

### CROSS-REFERENCE TO RELATED APPLICATION

This application is a continuation of International Application No. PCT/CN2016/093282, filed on Aug. 4, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to movable objects. More specifically, this disclosure relates to methods and systems for obstacle identification and avoidance for movable objects.

### BACKGROUND

Unmanned aerial vehicles (“UAV”), sometimes referred to as “drones,” include pilotless aircraft of various sizes and configurations that can be remotely operated by a user and/or programmed for automated flight. When a UAV is operated in an environment, the UAV may encounter various objects in its flight path. Some objects may partially or fully block the flight path or be located within a safe-flying (or safety) zone of the UAV, and become obstacles for the UAV.

UAVs with an automatic flying mode may automatically determine a flight path based on a destination provided by the user. In such situations, before takeoff, the UAV generates a flight path using a known map or locally saved map to identify and avoid identified obstacles. The flight path may be generated using a visual simultaneous localization and mapping (VSLAM) algorithm and a local three-dimensional map that includes information relating to objects (e.g., buildings, trees, etc.).

### SUMMARY

Certain embodiments of the present disclosure relate to a method of a movable object. The method includes obtaining an image of a surrounding of the movable object, and obtaining a plurality of depth layers based on the image. The method also includes projecting a safety zone of the movable object onto at least one of the depth layers, and determining whether an object is an obstacle based on a position of the object on the at least one of the depth layers relative to the projected safety zone. The method further includes adjusting a travel path of the movable object to travel around the obstacle.

In some embodiments of the method, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the method, the method further includes obtaining depth information of pixels of the image.

In some embodiments of the method, wherein obtaining the plurality of depth layers includes generating the depth layers based on the depth information of the pixels, each depth layer including pixels having a predetermined depth or a predetermined range of depth.

In some embodiments of the method, the method further includes projecting at least one of the flying tunnel or the crash tunnel onto the at least one of the depth layers.

In some embodiments of the method, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the method, the method further includes determining a size of the safety zone based on a size of the movable object and a current velocity of the movable object.

In some embodiments of the method, the method further includes determining a size of a projection of the flying tunnel on the at least one of the depth layers based on a size of the movable object, depth information of the one of the depth layers, and a current velocity of the movable object.

In some embodiments of the method, the method further includes determining a size of a projection of the crash tunnel on the one of the depth layers based on a size of the movable object and depth information of the one of the depth layers.

In some embodiments of the method, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the method, wherein counting the total number of pixels includes using a first weight to adjust a first number of pixels in a projection of the flying tunnel and a second weight to adjust a second number of pixels in a projection of the crash tunnel.

In some embodiments of the method, the method further includes determining that at least a portion of the object is within the safety zone when the total number of pixels is greater than a predetermined threshold.

In some embodiments of the method, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the method, the method further includes projecting a cage tunnel onto one of the depth layers, the cage tunnel including a width equal to a distance between two walls and a height equal to a height of a ceiling.

In some embodiments of the method, wherein adjusting the travel path includes calculating a smooth path that travels around the object.

In some embodiments of the method, wherein adjusting the travel path includes imposing a repulsive field onto at least one of a velocity field or an acceleration field of the movable object when the movable object is within a predetermined distance to the object.

In some embodiments of the method, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the method, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the method, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a system for a movable object. The system includes a controller including one or more processors configured to obtain an image of a surrounding of the movable object, and obtain a plurality of depth layers based on the image. The one or more processors are also configured to project a safety zone of the movable object onto at least one of the depth layers, and determine whether an object is an obstacle based on a position of the object on the at least one of the depth layers relative to the projected safety zone. The one or more processors are also configured to adjust a travel path of the movable object to travel around the obstacle.

In some embodiments of the system, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the system, wherein the one or more processors are also configured to obtain depth information of pixels of the image.

In some embodiments of the system, wherein obtaining the plurality of depth layers includes generating the depth layers based on the depth information of the pixels, each depth layer including pixels having a predetermined depth or a predetermined range of depth.

In some embodiments of the system, wherein the one or more processors are also configured to project at least one of the flying tunnel or the crash tunnel onto the at least one of the depth layers.

In some embodiments of the system, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the system, wherein the one or more processors are also configured to determine a size of the safety zone based on a size of the movable object and a current velocity of the movable object.

In some embodiments of the system, wherein the one or more processors are also configured to determine a size of a projection of the flying tunnel on the at least one of the depth layers based on a size of the movable object, depth information of the one of the depth layers, and a current velocity of the movable object.

In some embodiments of the system, wherein the one or more processors are also configured to determine a size of a projection of the crash tunnel on the one of the depth layers based on a size of the movable object and depth information of the one of the depth layers.

In some embodiments of the system, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the system, wherein counting the total number of pixels includes using a first weight to adjust a first number of pixels in a projection of the flying tunnel and a second weight to adjust a second number of pixels in a projection of the crash tunnel.

In some embodiments of the system, wherein the one or more processors are also configured to determine that at least a portion of the object is within the safety zone when the total number of pixels is greater than a predetermined threshold.

In some embodiments of the system, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the system, wherein the one or more processors are also configured to project a cage tunnel onto one of the depth layers, the cage tunnel including a width equal to a distance between two walls and a height equal to a height of a ceiling.

In some embodiments of the system, wherein adjusting the travel path includes calculating a smooth path that travels around the object.

In some embodiments of the system, wherein adjusting the travel path includes imposing a repulsive field onto at least one of a velocity field or an acceleration field of the movable object when the movable object is within a predetermined distance to the object.

In some embodiments of the system, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the system, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the system, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to an unmanned aerial vehicle (UAV) system. The UAV system includes one or more propulsion devices and a controller in communication with the one or more propulsion devices and including one or more processors. The one or more processors are configured to obtain an image of a surrounding of the movable object, and obtain a plurality of depth layers based on the image. The one or more processors are also configured to project a safety zone of the movable object onto at least one of the depth layers, and determine whether an object is an obstacle based on a position of the object on the at least one of the depth layers relative to the projected safety zone. The one or more processors are also configured to adjust a travel path of the movable object to travel around the obstacle.

In some embodiments of the UAV system, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the UAV system, wherein the one or more processors are also configured to obtain depth information of pixels of the image.

In some embodiments of the UAV system, wherein obtaining the plurality of depth layers includes generating the depth layers based on the depth information of the pixels, each depth layer including pixels having a predetermined depth or a predetermined range of depth.

In some embodiments of the UAV system, wherein the one or more processors are also configured to project at least one of the flying tunnel or the crash tunnel onto the at least one of the depth layers.

In some embodiments of the UAV system, wherein projecting at least one of the flying tunnel or the crash tunnel onto the at least one of the depth layers includes determining a location of a projection of at least one of the flying tunnel or the crash tunnel on the at least one of the depth layers based on a current velocity of the UAV.

In some embodiments of the UAV system, wherein the one or more processors are also configured to determine a size of the safety zone based on a size of the UAV and a current velocity of the UAV.

In some embodiments of the UAV system, wherein the one or more processors are also configured to determine a size of a projection of the flying tunnel on the at least one of the depth layers based on a size of the UAV, depth information of the one of the depth layers, and a current velocity of the UAV.

In some embodiments of the UAV system, wherein the one or more processors are also configured to determine a size of a projection of the crash tunnel on the one of the depth layers based on a size of the UAV and depth information of the one of the depth layers.

In some embodiments of the UAV system, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the UAV system, wherein counting the total number of pixels includes using a first weight to adjust a first number of pixels in a projection of the flying tunnel and a second weight to adjust a second number of pixels in a projection of the crash tunnel.

In some embodiments of the UAV system, wherein the one or more processors are also configured to determine that at least a portion of the object is within the safety zone when the total number of pixels is greater than a predetermined threshold.

In some embodiments of the UAV system, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the UAV system, wherein the one or more processors are also configured to project a cage tunnel onto one of the depth layers, the cage tunnel including a width equal to a distance between two walls and a height equal to a height of a ceiling.

In some embodiments of the UAV system, wherein adjusting the travel path includes calculating a smooth path that travels around the object.

In some embodiments of the UAV system, wherein adjusting the travel path includes imposing a repulsive field onto at least one of a velocity field or an acceleration field of the UAV when the UAV is within a predetermined distance to the object.

In some embodiments of the UAV system, wherein adjusting the travel path includes: reducing a speed of the UAV using a predetermined braking speed determined based on depth information of the object when the UAV is out of a predetermined distance to the object; and imposing a repulsive field onto at least one of a velocity field or an acceleration field of the UAV when the UAV is within the predetermined distance to the object.

In some embodiments of the UAV system, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the UAV system, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a non-transitory computer-readable medium storing instructions that, when executed by a computer, cause the computer to perform a method. The method includes obtaining an image of a surrounding of the movable object, and obtaining a plurality of depth layers based on the image. The method also includes projecting a safety zone of the movable object onto at least one of the depth layers, and determining whether an object is an obstacle based on a position of the object on the at least one of the depth layers relative to the projected safety zone. The method further includes adjusting a travel path of the movable object to travel around the obstacle.

In some embodiments of the non-transitory computer-readable medium, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the non-transitory computer-readable medium, the method further includes obtaining depth information of pixels of the image.

In some embodiments of the non-transitory computer-readable medium, wherein obtaining the plurality of depth layers includes generating the depth layers based on the depth information of the pixels, each depth layer including pixels having a predetermined depth or a predetermined range of depth.

In some embodiments of the non-transitory computer-readable medium, the method further includes projecting at least one of the flying tunnel or the crash tunnel onto the at least one of the depth layers.

In some embodiments of the non-transitory computer-readable medium, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the non-transitory computer-readable medium, the method further includes determining a size of the safety zone based on a size of the movable object and a current velocity of the movable object.

In some embodiments of the non-transitory computer-readable medium, the method further includes determining a size of a projection of the flying tunnel on the at least one of the depth layers based on a size of the movable object, depth information of the one of the depth layers, and a current velocity of the movable object.

In some embodiments of the non-transitory computer-readable medium, the method further includes determining a size of a projection of the crash tunnel on the one of the depth layers based on a size of the movable object and depth information of the one of the depth layers.

In some embodiments of the non-transitory computer-readable medium, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the non-transitory computer-readable medium, wherein counting the total number of pixels includes using a first weight to adjust a first number of pixels in a projection of the flying tunnel and a second weight to adjust a second number of pixels in a projection of the crash tunnel.

In some embodiments of the non-transitory computer-readable medium, the method further includes determining that at least a portion of the object is within the safety zone when the total number of pixels is greater than a predetermined threshold.

In some embodiments of the non-transitory computer-readable medium, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the non-transitory computer-readable medium, wherein the method further includes projecting a cage tunnel onto one of the depth layers, the cage tunnel including a width equal to a distance between two walls and a height equal to a height of a ceiling.

In some embodiments of the non-transitory computer-readable medium, wherein adjusting the travel path includes calculating a smooth path that travels around the object.

In some embodiments of the non-transitory computer-readable medium, wherein adjusting the travel path includes imposing a repulsive field onto at least one of a velocity field or an acceleration field of the movable object when the movable object is within a predetermined distance to the object.

In some embodiments of the non-transitory computer-readable medium, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the non-transitory computer-readable medium, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the non-transitory computer-readable medium, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a method of a movable object. The method includes detecting an object in a safety zone of the movable object as the movable object moves. The method also includes adjusting a travel path of the movable object to travel around the object.

In some embodiments of the method, wherein detecting the object in the safety zone includes detecting the object using at least one of an image sensor, a radar sensor, a laser sensor, an infrared sensor, an ultrasonic sensor, and a time-of-flight sensor.

In some embodiments of the method, wherein the safety zone includes at least one of a flying tunnel or a crash tunnel, and wherein detecting the object includes analyzing the position of the object with at least one of the flying tunnel or the crash tunnel as projected onto the at least one of the depth layers.

In some embodiments of the method, the method further includes obtaining depth information of pixels of the image.

In some embodiments of the method, wherein obtaining the plurality of depth layers includes generating the depth layers based on the depth information of the pixels, each depth layer including pixels having a predetermined depth or a predetermined range of depth.

In some embodiments of the method, the method further includes projecting at least one of the flying tunnel or the crash tunnel onto the at least one of the depth layers.

In some embodiments of the method, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the method, the method further includes determining a size of the safety zone based on a size of the movable object and a current velocity of the movable object.

In some embodiments of the method, the method further includes determining a size of a projection of the flying tunnel on the at least one of the depth layers based on a size of the movable object, depth information of the one of the depth layers, and a current velocity of the movable object.

In some embodiments of the method, the method further includes determining a size of a projection of the crash tunnel on the one of the depth layers based on a size of the movable object and depth information of the one of the depth layers.

In some embodiments of the method, wherein detecting the object based on the position of the object on the at least one of the depth layers relative to the projected safety zone includes counting a total number of pixels of the object within a projection of at least one of the flying tunnel or the crash tunnel.

In some embodiments of the method, wherein counting the total number of pixels includes using a first weight to adjust a first number of pixels in a projection of the flying tunnel and a second weight to adjust a second number of pixels in a projection of the crash tunnel.

In some embodiments of the method, the method further includes determining that at least a portion of the object is within the safety zone when the total number of pixels is greater than a predetermined threshold.

In some embodiments of the method, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the method, wherein the method further includes projecting a cage tunnel onto one of the depth layers, the cage tunnel including a width equal to a distance between two walls and a height equal to a height of a ceiling.

In some embodiments of the method, wherein adjusting the travel path includes calculating a smooth path that travels around the object.

In some embodiments of the method, wherein adjusting the travel path includes imposing a repulsive field onto at least one of a velocity field or an acceleration field of the movable object when the movable object is within a predetermined distance to the object.

In some embodiments of the method, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the method, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the method, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a system for a movable object. The system includes a controller including one or more processors configured to: detect an object in a safety zone of the movable object as the movable object moves; and adjust a travel path of the movable object to travel around the object.

In some embodiments of the system, wherein detecting the object in the safety zone includes detecting the object using at least one of an image sensor, a radar sensor, a laser sensor, an infrared sensor, an ultrasonic sensor, and a time-of-flight sensor.

In some embodiments of the system, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the system, wherein the one or more processors are also configured to obtain depth information of pixels of the image.

In some embodiments of the system, wherein obtaining the plurality of depth layers includes generating the depth layers based on the depth information of the pixels, each depth layer including pixels having a predetermined depth or a predetermined range of depth.

In some embodiments of the system, wherein the one or more processors are also configured to project at least one of the flying tunnel or the crash tunnel onto the at least one of the depth layers.

In some embodiments of the system, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the system, wherein the one or more processors are also configured to determine a size of the safety zone based on a size of the movable object and a current velocity of the movable object.

In some embodiments of the system, wherein the one or more processors are also configured to determine a size of a projection of the flying tunnel on the at least one of the depth layers based on a size of the movable object, depth information of the one of the depth layers, and a current velocity of the movable object.

In some embodiments of the system, wherein the one or more processors are also configured to determine a size of a projection of the crash tunnel on the one of the depth layers based on a size of the movable object and depth information of the one of the depth layers.

In some embodiments of the system, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the system, wherein counting the total number of pixels includes using a first weight to adjust a first number of pixels in a projection of the flying tunnel and a second weight to adjust a second number of pixels in a projection of the crash tunnel.

In some embodiments of the system, wherein the one or more processors are also configured to determine that at least a portion of the object is within the safety zone when the total number of pixels is greater than a predetermined threshold.

In some embodiments of the system, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the system, wherein the one or more processors are also configured to project a cage tunnel onto one of the depth layers, the cage tunnel including a width equal to a distance between two walls and a height equal to a height of a ceiling.

In some embodiments of the system, wherein adjusting the travel path includes calculating a smooth path that travels around the object.

In some embodiments of the system, wherein adjusting the travel path includes imposing a repulsive field onto at least one of a velocity field or an acceleration field of the movable object when the movable object is within a predetermined distance to the object.

In some embodiments of the system, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the system, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the system, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to an unmanned aerial vehicle (UAV) system. The UAV system includes one or more propulsion devices, such as propellers or propulsors. The UAV system also includes a controller in communication with the one or more propulsion devices and including one or more processors configured to detect an object in a safety zone of the UAV as the UAV moves; and adjust a travel path of the UAV to travel around the object.

In some embodiments of the UAV system, wherein detecting the object in the safety zone includes detecting the object using at least one of an image sensor, a radar sensor, a laser sensor, an infrared sensor, an ultrasonic sensor, and a time-of-flight sensor.

In some embodiments of the UAV system, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the UAV system, wherein the one or more processors are also configured to obtain depth information of pixels of the image.

In some embodiments of the UAV system, wherein obtaining the plurality of depth layers includes generating the depth layers based on the depth information of the pixels, each depth layer including pixels having a predetermined depth or a predetermined range of depth.

In some embodiments of the UAV system, wherein the one or more processors are also configured to project at least one of the flying tunnel or the crash tunnel onto the at least one of the depth layers.

In some embodiments of the UAV system, wherein projecting at least one of the flying tunnel or the crash tunnel onto the at least one of the depth layers includes determining a location of a projection of at least one of the flying tunnel or the crash tunnel on the at least one of the depth layers based on a current velocity of the UAV.

In some embodiments of the UAV system, wherein the one or more processors are also configured to determine a size of the safety zone based on a size of the UAV and a current velocity of the UAV.

In some embodiments of the UAV system, wherein the one or more processors are also configured to determine a size of a projection of the flying tunnel on the at least one of the depth layers based on a size of the UAV, depth information of the one of the depth layers, and a current velocity of the UAV.

In some embodiments of the UAV system, wherein the one or more processors are also configured to determine a size of a projection of the crash tunnel on the one of the depth layers based on a size of the UAV and depth information of the one of the depth layers.

In some embodiments of the UAV system, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the UAV system, wherein counting the total number of pixels includes using a first weight to adjust a first number of pixels in a projection of the flying tunnel and a second weight to adjust a second number of pixels in a projection of the crash tunnel.

In some embodiments of the UAV system, wherein the one or more processors are also configured to determine that at least a portion of the object is within the safety zone when the total number of pixels is greater than a predetermined threshold.

In some embodiments of the UAV system, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the UAV system, wherein the one or more processors are also configured to project a cage tunnel onto one of the depth layers, the cage tunnel including a width equal to a distance between two walls and a height equal to a height of a ceiling.

In some embodiments of the UAV system, wherein adjusting the travel path includes calculating a smooth path that travels around the object.

In some embodiments of the UAV system, wherein adjusting the travel path includes imposing a repulsive field onto at least one of a velocity field or an acceleration field of the UAV when the UAV is within a predetermined distance to the object.

In some embodiments of the UAV system, wherein adjusting the travel path includes: reducing a speed of the UAV using a predetermined braking speed determined based on depth information of the object when the UAV is out of a predetermined distance to the object; and imposing a repulsive field onto at least one of a velocity field or an acceleration field of the UAV when the UAV is within the predetermined distance to the object.

In some embodiments of the UAV system, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the UAV system, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a non-transitory computer-readable medium storing instructions that, when executed by a computer, cause the computer to perform a method. The method includes detecting an object in a safety zone of a movable object as the movable object moves; and adjusting a travel path of the movable object to travel around the object.

In some embodiments of the non-transitory computer-readable medium, wherein detecting the object in the safety zone includes detecting the object using at least one of an image sensor, a radar sensor, a laser sensor, an infrared sensor, an ultrasonic sensor, and a time-of-flight sensor.

In some embodiments of the non-transitory computer-readable medium, wherein the safety zone includes at least one of a flying tunnel or a crash tunnel, and wherein detecting the object includes analyzing the position of the object with at least one of the flying tunnel or the crash tunnel as projected onto the at least one of the depth layers.

In some embodiments of the non-transitory computer-readable medium, wherein the method further includes obtaining depth information of pixels of the image.

In some embodiments of the non-transitory computer-readable medium, wherein obtaining the plurality of depth layers includes generating the depth layers based on the depth information of the pixels, each depth layer including pixels having a predetermined depth or a predetermined range of depth.

In some embodiments of the non-transitory computer-readable medium, the method further includes projecting at least one of the flying tunnel or the crash tunnel onto the at least one of the depth layers.

In some embodiments of the non-transitory computer-readable medium, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the non-transitory computer-readable medium, the method further includes determining a size of the safety zone based on a size of the movable object and a current velocity of the movable object.

In some embodiments of the non-transitory computer-readable medium, the method further includes determining a size of a projection of the flying tunnel on the at least one of the depth layers based on a size of the movable object, depth information of the one of the depth layers, and a current velocity of the movable object.

In some embodiments of the non-transitory computer-readable medium, the method further includes determining a size of a projection of the crash tunnel on the one of the depth layers based on a size of the movable object and depth information of the one of the depth layers.

In some embodiments of the non-transitory computer-readable medium, wherein detecting the object based on the position of the object on the at least one of the depth layers relative to the projected safety zone includes counting a total number of pixels of the object within a projection of at least one of the flying tunnel or the crash tunnel.

In some embodiments of the non-transitory computer-readable medium, wherein counting the total number of pixels includes using a first weight to adjust a first number of pixels in a projection of the flying tunnel and a second weight to adjust a second number of pixels in a projection of the crash tunnel.

In some embodiments of the non-transitory computer-readable medium, the method further includes determining that at least a portion of the object is within the safety zone when the total number of pixels is greater than a predetermined threshold.

In some embodiments of the non-transitory computer-readable medium, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the non-transitory computer-readable medium, wherein the method further includes projecting a cage tunnel onto one of the depth layers, the cage tunnel including a width equal to a distance between two walls and a height equal to a height of a ceiling.

In some embodiments of the non-transitory computer-readable medium, wherein adjusting the travel path includes calculating a smooth path that travels around the object.

In some embodiments of the non-transitory computer-readable medium, wherein adjusting the travel path includes imposing a repulsive field onto at least one of a velocity field or an acceleration field of the movable object when the movable object is within a predetermined distance to the object.

In some embodiments of the non-transitory computer-readable medium, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the non-transitory computer-readable medium, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the non-transitory computer-readable medium, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a method of a movable object. The method includes estimating an impact of an object on a travel path of the movable object as the movable object moves; and adjusting the travel path of the movable object based on the estimated impact.

In some embodiments of the method, wherein estimating the impact of the object includes detecting the object within a safety zone of the movable object.

In some embodiments of the method, wherein detecting the object in the safety zone includes detecting the object using at least one of an image sensor, a radar sensor, a laser sensor, an infrared sensor, an ultrasonic sensor, and a time-of-flight sensor.

In some embodiments of the method, wherein the safety zone includes at least one of a flying tunnel or a crash tunnel, and wherein detecting the object includes analyzing the position of the object with at least one of the flying tunnel or the crash tunnel as projected onto the at least one of the depth layers.

In some embodiments of the method, method further includes obtaining depth information of pixels of the image.

In some embodiments of the method, wherein obtaining the plurality of depth layers includes generating the depth layers based on the depth information of the pixels, each depth layer including pixels having a predetermined depth or a predetermined range of depth.

In some embodiments of the method, the method further includes projecting at least one of the flying tunnel or the crash tunnel onto the at least one of the depth layers.

In some embodiments of the method, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the method, the method further includes determining a size of the safety zone based on a size of the movable object and a current velocity of the movable object.

In some embodiments of the method, the method further includes determining a size of a projection of the flying tunnel on the at least one of the depth layers based on a size of the movable object, depth information of the one of the depth layers, and a current velocity of the movable object.

In some embodiments of the method, the method further includes determining a size of a projection of the crash tunnel on the one of the depth layers based on a size of the movable object and depth information of the one of the depth layers.

In some embodiments of the method, wherein detecting the object based on the position of the object on the at least one of the depth layers relative to the projected safety zone includes counting a total number of pixels of the object within a projection of at least one of the flying tunnel or the crash tunnel.

In some embodiments of the method, wherein counting the total number of pixels includes using a first weight to adjust a first number of pixels in a projection of the flying tunnel and a second weight to adjust a second number of pixels in a projection of the crash tunnel.

In some embodiments of the method, the method further includes determining that at least a portion of the object is within the safety zone when the total number of pixels is greater than a predetermined threshold.

In some embodiments of the method, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the method, wherein the method further includes projecting a cage tunnel onto one of the depth layers, the cage tunnel including a width equal to a distance between two walls and a height equal to a height of a ceiling.

In some embodiments of the method, wherein adjusting the travel path includes calculating a smooth path that travels around the object.

In some embodiments of the method, wherein adjusting the travel path includes imposing a repulsive field onto at least one of a velocity field or an acceleration field of the movable object when the movable object is within a predetermined distance to the object.

In some embodiments of the method, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the method, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the method, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a system for a movable object. The system includes a controller including one or more processors configured to estimate an impact of the object on a travel path of the movable object as the movable object moves; and adjust the travel path of the movable object based on the estimated impact.

In some embodiments of the system, estimating the impact of the object includes detecting the object within a safety zone of the movable object.

In some embodiments of the system, wherein detecting the object in the safety zone includes detecting the object using at least one of an image sensor, a radar sensor, a laser sensor, an infrared sensor, an ultrasonic sensor, and a time-of-flight sensor.

In some embodiments of the system, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the system, wherein the one or more processors are also configured to obtain depth information of pixels of the image.

In some embodiments of the system, wherein obtaining the plurality of depth layers includes generating the depth layers based on the depth information of the pixels, each depth layer including pixels having a predetermined depth or a predetermined range of depth.

In some embodiments of the system, wherein the one or more processors are also configured to project at least one of the flying tunnel or the crash tunnel onto the at least one of the depth layers.

In some embodiments of the system, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the system, wherein the one or more processors are also configured to determine a size of the safety zone based on a size of the movable object and a current velocity of the movable object.

In some embodiments of the system, wherein the one or more processors are also configured to determine a size of a projection of the flying tunnel on the at least one of the depth layers based on a size of the movable object, depth information of the one of the depth layers, and a current velocity of the movable object.

In some embodiments of the system, wherein the one or more processors are also configured to determine a size of a projection of the crash tunnel on the one of the depth layers based on a size of the movable object and depth information of the one of the depth layers.

In some embodiments of the system, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the system, wherein counting the total number of pixels includes using a first weight to adjust a first number of pixels in a projection of the flying tunnel and a second weight to adjust a second number of pixels in a projection of the crash tunnel.

In some embodiments of the system, wherein the one or more processors are also configured to determine that at least a portion of the object is within the safety zone when the total number of pixels is greater than a predetermined threshold.

In some embodiments of the system, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the system, wherein the one or more processors are also configured to project a cage tunnel onto one of the depth layers, the cage tunnel including a width equal to a distance between two walls and a height equal to a height of a ceiling.

In some embodiments of the system, wherein adjusting the travel path includes calculating a smooth path that travels around the object.

In some embodiments of the system, wherein adjusting the travel path includes imposing a repulsive field onto at least one of a velocity field or an acceleration field of the movable object when the movable object is within a predetermined distance to the object.

In some embodiments of the system, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the system, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the system, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to an unmanned aerial vehicle (UAV) system. The UAV system includes one or more propulsion devices. The UAV system also includes a controller in communication with the one or more propulsion devices and including one or more processors configured to: estimate an impact of an object on a travel path of the UAV as the UAV moves; and adjust the travel path of the UAV based on the estimated impact.

In some embodiments of the UAV system, estimating the impact of the object includes detecting the object within a safety zone of the UAV.

In some embodiments of the UAV system, wherein detecting the object in the safety zone includes detecting the object using at least one of an image sensor, a radar sensor, a laser sensor, an infrared sensor, an ultrasonic sensor, and a time-of-flight sensor.

In some embodiments of the UAV system, wherein the safety zone includes at least one of a flying tunnel or a crash tunnel, and wherein determining whether the object is an obstacle includes analyzing the position of the object with at least one of the flying tunnel or the crash tunnel as projected onto the at least one of the depth layers.

In some embodiments of the UAV system, wherein the one or more processors are also configured to obtain depth information of pixels of the image.

In some embodiments of the UAV system, wherein obtaining the plurality of depth layers includes generating the depth layers based on the depth information of the pixels, each depth layer including pixels having a predetermined depth or a predetermined range of depth.

In some embodiments of the UAV system, wherein the one or more processors are also configured to project at least one of the flying tunnel or the crash tunnel onto the at least one of the depth layers.

In some embodiments of the UAV system, wherein projecting at least one of the flying tunnel or the crash tunnel onto the at least one of the depth layers includes determining a location of a projection of at least one of the flying tunnel or the crash tunnel on the at least one of the depth layers based on a current velocity of the UAV.

In some embodiments of the UAV system, wherein the one or more processors are also configured to determine a size of the safety zone based on a size of the UAV and a current velocity of the UAV.

In some embodiments of the UAV system, wherein the one or more processors are also configured to determine a size of a projection of the flying tunnel on the at least one of the depth layers based on a size of the UAV, depth information of the one of the depth layers, and a current velocity of the UAV.

In some embodiments of the UAV system, wherein the one or more processors are also configured to determine a size of a projection of the crash tunnel on the one of the depth layers based on a size of the UAV and depth information of the one of the depth layers.

In some embodiments of the UAV system, wherein determining whether an object is an obstacle based on the position of the object on the at least one of the depth layers relative to the projected safety zone includes counting a total number of pixels of the object within a projection of at least one of the flying tunnel or the crash tunnel.

In some embodiments of the UAV system, wherein counting the total number of pixels includes using a first weight to adjust a first number of pixels in a projection of the flying tunnel and a second weight to adjust a second number of pixels in a projection of the crash tunnel.

In some embodiments of the UAV system, wherein the one or more processors are also configured to determine that at least a portion of the object is within the safety zone when the total number of pixels is greater than a predetermined threshold.

In some embodiments of the UAV system, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the UAV system, wherein the one or more processors are also configured to project a cage tunnel onto one of the depth layers, the cage tunnel including a width equal to a distance between two walls and a height equal to a height of a ceiling.

In some embodiments of the UAV system, wherein adjusting the travel path includes calculating a smooth path that travels around the object.

In some embodiments of the UAV system, wherein adjusting the travel path includes imposing a repulsive field onto at least one of a velocity field or an acceleration field of the UAV when the UAV is within a predetermined distance to the object.

In some embodiments of the UAV system, wherein adjusting the travel path includes: reducing a speed of the UAV using a predetermined braking speed determined based on depth information of the object when the UAV is out of a predetermined distance to the object; and imposing a repulsive field onto at least one of a velocity field or an acceleration field of the UAV when the UAV is within the predetermined distance to the object.

In some embodiments of the UAV system, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the UAV system, wherein when at least one of a wall and ground is detected, adjusting the travel path includes allowing parallel travel along at least one of the wall and the ground, while maintaining a predetermined distance to at least one of the wall and the ground.

Certain embodiments of the present disclosure relate to a non-transitory computer-readable medium storing instructions that, when executed by a computer, cause the computer to perform a method. The method includes estimating an impact of an object on a travel path of a movable object as the movable object moves; and adjusting the travel path of the movable object based on the estimated impact.

In some embodiments of the non-transitory computer-readable medium, wherein estimating the impact of the object includes detecting the object within a safety zone of the movable object.

In some embodiments of the non-transitory computer-readable medium, wherein detecting the object in the safety zone includes detecting the object using at least one of an image sensor, a radar sensor, a laser sensor, an infrared sensor, an ultrasonic sensor, and a time-of-flight sensor.

In some embodiments of the non-transitory computer-readable medium, wherein the safety zone includes at least one of a flying tunnel or a crash tunnel, and wherein detecting the object includes analyzing the position of the object with at least one of the flying tunnel or the crash tunnel as projected onto the at least one of the depth layers.

In some embodiments of the non-transitory computer-readable medium, method further includes obtaining depth information of pixels of the image.

In some embodiments of the non-transitory computer-readable medium, wherein obtaining the plurality of depth layers includes generating the depth layers based on the depth information of the pixels, each depth layer including pixels having a predetermined depth or a predetermined range of depth.

In some embodiments of the non-transitory computer-readable medium, the method further includes projecting at least one of the flying tunnel or the crash tunnel onto the at least one of the depth layers.

In some embodiments of the non-transitory computer-readable medium, wherein projecting at least one of the flying tunnel or the crash tunnel onto the at least one of the depth layers includes determining a location of a projection of at least one of the flying tunnel or the crash tunnel on the at least one of the depth layers based on a current velocity of the movable object.

In some embodiments of the non-transitory computer-readable medium, the method further includes determining a size of the safety zone based on a size of the movable object and a current velocity of the movable object.

In some embodiments of the non-transitory computer-readable medium, the method further includes determining a size of a projection of the flying tunnel on the at least one of the depth layers based on a size of the movable object, depth information of the one of the depth layers, and a current velocity of the movable object.

In some embodiments of the non-transitory computer-readable medium, the method further includes determining a size of a projection of the crash tunnel on the one of the depth layers based on a size of the movable object and depth information of the one of the depth layers.

In some embodiments of the non-transitory computer-readable medium, wherein detecting the object based on the position of the object on the at least one of the depth layers relative to the projected safety zone includes counting a total number of pixels of the object within a projection of at least one of the flying tunnel or the crash tunnel.

In some embodiments of the non-transitory computer-readable medium, wherein counting the total number of pixels includes using a first weight to adjust a first number of pixels in a projection of the flying tunnel and a second weight to adjust a second number of pixels in a projection of the crash tunnel.

In some embodiments of the non-transitory computer-readable medium, the method further includes determining that at least a portion of the object is within the safety zone when the total number of pixels is greater than a predetermined threshold.

In some embodiments of the non-transitory computer-readable medium, wherein detecting the object further includes detecting at least one of ground or a wall within a projection of at least one of the flying tunnel or the crash tunnel, and wherein counting the total number of pixels includes excluding the pixels of at least one of the ground or the wall within the projection of at least one of the flying tunnel or the crash tunnel.

In some embodiments of the non-transitory computer-readable medium, wherein the method further includes projecting a cage tunnel onto one of the depth layers, the cage tunnel including a width equal to a distance between two walls and a height equal to a height of a ceiling.

In some embodiments of the non-transitory computer-readable medium, wherein adjusting the travel path includes calculating a smooth path that travels around the object.

In some embodiments of the non-transitory computer-readable medium, wherein adjusting the travel path includes imposing a repulsive field onto at least one of a velocity field or an acceleration field of the movable object when the movable object is within a predetermined distance to the object.

In some embodiments of the non-transitory computer-readable medium, wherein adjusting the travel path includes: reducing a speed of the movable object using a predetermined braking speed determined based on depth information of the object when the movable object is out of a predetermined distance to the object; and imposing a repulsive field onto at least one of a velocity field or an acceleration field of the movable object when the movable object is within the predetermined distance to the object.

In some embodiments of the non-transitory computer-readable medium, wherein determining whether an object is an obstacle includes determining that the object is a large object by determining that the object will occupy a predetermined percentage of an image frame in an amount of travel time, and wherein adjusting the travel path includes adjusting the travel path to avoid getting too close to the object before the object occupies the predetermined percentage of the image frame.

In some embodiments of the non-transitory computer-readable medium, wherein when at least one of a wall and ground is detected, adjusting the travel path includes allowing parallel travel along at least one of the wall and the ground, while maintaining a predetermined distance to at least one of the wall and the ground.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the disclosed principles. In the drawings:

FIG. 1 illustrates an exemplary movable object, consistent with the disclosed embodiments.

FIG. 2 schematically illustrates an exemplary structure of a control terminal, consistent with the disclosed embodiments.

FIG. 3 schematically illustrates an exemplary structure of a controller, consistent with the disclosed embodiments.

FIG. 4 illustrates an exemplary method for identifying an object as an obstacle and avoiding the obstacle, consistent with the disclosed embodiments.

FIG. 5 illustrates an exemplary process for generating a plurality of depth layers from one or more images, consistent with the disclosed embodiments.

FIG. 6 is a flowchart illustrating an exemplary method for processing an image to obtain depth information, consistent with the disclosed embodiments.

FIG. 7 illustrates an exemplary safety zone of a movable object, consistent with the disclosed embodiments.

FIG. 8 is a flowchart illustrating an exemplary method for detecting an object in a safety zone of a movable object, consistent with the disclosed embodiments.

FIG. 9 schematically illustrates an exemplary method for projecting a flying tunnel and a crash tunnel onto a depth layer, consistent with the disclosed embodiments.

FIG. 10 schematically illustrates an exemplary method for determining a location of a flying tunnel and/or a crash tunnel projected onto a depth layer in a depth space associated with a certain depth, consistent with the disclosed embodiments.

FIGS. 11A and 11B illustrate an exemplary method for determining a location of a center of a projection of a flying tunnel and/or a crash tunnel, consistent with the disclosed embodiments.

FIG. 12 illustrates an exemplary method for determining whether an object is within a safety zone of a movable object, consistent with the disclosed embodiments.

FIG. 13 illustrates an exemplary method for adjusting a travel path of a movable object to avoid a detected object, consistent with the disclosed embodiments.

FIG. 14 schematically illustrates an exemplary method for adjusting a travel path of a movable object when a large object is detected, consistent with the disclosed embodiments.

FIG. 15 illustrates an exemplary method for identifying a wall and/or ground when a movable object travels within an enclosed environment, consistent with the disclosed embodiments.

FIG. 16 schematically illustrates a cage tunnel and an image frame, consistent with the disclosed embodiments.

FIG. 17 illustrates a result of projecting a cage tunnel onto a depth layer having a certain depth, consistent with the disclosed embodiments.

FIG. 18 is a flowchart illustrating an exemplary method for a movable object, consistent with the disclosed embodiments.

FIG. 19 is a flowchart illustrating another exemplary method for a movable object, consistent with the disclosed embodiments.

FIG. 20 is a flowchart illustrating yet another exemplary method for a movable object, consistent with the disclosed embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be interpreted as open ended, in that, an item or items following any one of these words is not meant to be an exhaustive listing of such item or items, or meant to be limited to only the listed item or items.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems and methods described herein should not be construed as limiting in any way. Instead, the present disclosure is directed toward all novel and non-obvious features and aspects of the various disclosed embodiments, alone and in various combinations and sub-combinations with one another. The disclosed systems and methods are not limited to any specific aspect or feature or combinations thereof, nor do the disclosed systems and methods require that any one or more specific advantages be present or problems be solved. Any theories of operation are to facilitate explanation, but the disclosed systems, methods, and apparatus are not limited to such theories of operation.

For example, embodiments described herein use UAVs as examples of a movable object. But a movable object in this disclosure and accompanying claims is not so limited, and may be any object that is capable of moving on its own or under control of a user, such as an autonomous vehicle, a human operated vehicle, a boat, a smart balancing vehicle, a radio controlled vehicle, a robot, a wearable device (such as smart glasses, augmented reality or virtual reality glasses or helmet), etc. The term “travel path” herein generally refers to the path or route of the movable object, for example, the flight path of a UAV.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Systems and methods consistent with the present disclosure are directed to detecting an object that might enter a safety zone of a movable object and potentially cause crash, and adjusting a travel path of the movable object to travel around the detected object. The movable object may detect the object in the safety zone of the movable object as the movable object moves.

A safety zone refers to a space in which the movable object may travel safely without colliding into an object (e.g., an obstacle) or getting too close to the object. The safety zone may be defined as a zone or space around the movable object and moving with the movable object, or may be defined as a zone or space along a projected or calculated flight path and may change as the flight path changes. A safety zone is a virtually defined space, i.e., without any actual barrier or other physical presence to delineate the boundary of the zone.

A safety zone may further have sub-zones reflecting varying safety or danger levels for the movable object. For example, in some embodiments, a safety zone for a UAV may be defined to have a flying tunnel and a crash tunnel within the flying tunnel. Both the flying tunnel and the crash tunnel are virtual three-dimensional spaces along the direction of flight of the UAV and may have any suitable cross-sectional shape, such as rectangle, oval, circle, etc. The flying tunnel has a cross-sectional size generally larger, by a certain amount of margin, than the physical dimensions of the UAV to provide some room for error or disturbance to the path. The crash tunnel may be defined as a tunnel around the flight path of the UAV and have a cross-sectional size similar to, or barely larger than, the physical dimensions of the UAV. As the UAV flies, any object that may enter into the crash tunnel even to a very small extent very likely will collide with the UAV. As such, objects outside the flying tunnel are considered safe to the UAV; objects inside the flying tunnel but outside the crash tunnel are considered to present medium threat; and objects inside the crash tunnel are considered dangerous.

Other suitable ways may also be used define a safety zone. For example, a safety zone may vary, either predetermined or real-time, based on the speed of the movable object, the environment of the movable object such as temperature, weather, natural surroundings (e.g., water vs. rocky mountains vs. marshes). For example, as the movable object moves faster, the safety zone may be adjusted to increase its dimensions; and the safety zone near a rocky mountain may need to have greater dimensions than near water, because a crash into the mountain may lead to complete destruction of the movable object.

The movable object may include one or more sensors, such as an imaging device (e.g., a camera or a stereo vision system that includes at least two cameras), a radar, a laser, an infrared sensor, an ultrasonic sensor, and/or a time-of-flight sensor. The imaging device may capture images of the environment around the movable object.

The movable object may include a controller having one or more processors configured to process the images to obtain depth information of objects on the images and generate a depth map. The controller may further generate a plurality of depth images or depth layers, based on the depth information, each depth image or depth layer capturing objects having a certain depth, i.e., a certain distance from the movable object.

The controller may analyze the depth image or depth layer with a particular depth to determine if any object on the image may have an impact on the safety zone. In one example, a flying tunnel and/or crash tunnel defined for a UAV may be projected onto the depth layers having depths of, e.g., 3 meters or 10 meters, depending on the velocity of the UAV or other flying conditions. In this example, impact of objects on the 3-meter depth image, if found in the safety zone (flying tunnel or crash tunnel), would be more significant and imminent. To identify objects in the safety zone, the controller may be configured to count a total number of pixels of objects within the projected flying tunnel and crash tunnel and determine that at least a portion of the object is within the safety zone when that total number of pixels is greater than a predetermined threshold. For example, the controller may determine that an object is within the safety zone if the total number of pixels of the object appearing within the projected flying zone is greater than 10 pixels or the total number of pixels of the object appearing within the projected crash zone is greater than 5 pixels. Once an object is so detected and considered an obstacle, the controller may adjust the travel path of the UAV to fly around the object or obstacle. For example, the movable object may adjust the travel path to smoothly circumvent (e.g., go around) the object without causing an abrupt change in the travel path (e.g., an abrupt stop or a sharp turn).

In one aspect, the controller may determine whether the object is within the safety zone based on a position of the object in the depth layers relative to the projected safety zone (e.g., the projected flying tunnel and/or crash tunnel on the depth layers). In some embodiments, the controller may count a total number of pixels of the object within the projected flying tunnel and crash tunnel using different weights. The controller may determine that at least a portion of the object is within the safety zone when the total number of pixels is greater than a predetermined threshold (e.g., 10 pixels, 20 pixels, etc.). Based on detecting the object, the controller may adjust the travel path of the movable object to travel around the object. For example, the movable object may adjust the travel path to smoothly circumvent (e.g., go around) the object without causing an abrupt change in the travel path (e.g., an abrupt stop or a sharp turn).

The controller may adjust the travel path by emulating a repulsive field and imposing the repulsive field onto at least one of the velocity field or the acceleration field of the movable object when the movable object is within a predetermined distance (e.g., 5 meters, 3 meters, etc.) to the object. In some embodiments, the controller may control propulsion devices of the movable object to cause the movable object to brake when the movable object is more than the predetermined distance from the detected object. In controlling the propulsion devices to reduce the speed, the controller may use a maximum braking speed corresponding to a depth related to the detected object.

When a large object (e.g., a building) is detected within the safety zone, the controller may adjust the travel path in advance before the movable object gets too close to the large object. If the movable object is too close to the large object, the large object may occupy a large percentage of an image frame of the movable object, making it difficult for the movable object to find a way around the large object. The adjusted travel path may prevent the movable object from getting too close to the large object. The movable object may travel along the adjust travel path before it reaches a point on the original travel path that is too close to the large object.

When the movable object moves in an enclosed environment with barriers such as walls, floor, and ceiling, the controller may falsely identify the barriers as obstacles. Particularly, when a portion of the ground and/or wall is detected within the flying tunnel and/or the crash tunnel, counting the number of pixels as described above may identify ground or the wall as an obstacle, even though the movable object is moving in parallel with and would not crash into ground or the wall. Thus, in one aspect, the controller may be configured to exclude the pixels of ground and/or wall on the depth layer within the projected flying tunnel and/or crash tunnel during counting. In this way, the ground and/or wall will not be treated as an obstacle, and the movable object may continue to travel in parallel with ground and/or the wall while maintaining a predetermined safe distance therefrom; the movable object does not need to stop moving and the controller does not need to alter the travel path for the movable object.

Objects may be detected using a distance measuring or object detecting sensor, such as a stereo vision system, an ultrasonic sensor, an infrared sensor, a laser sensor, a radar sensor, or a time-of-flight sensor. The disclosed obstacle avoidance systems and methods may be applicable when one or more of such distance measuring or object detecting sensor are used.

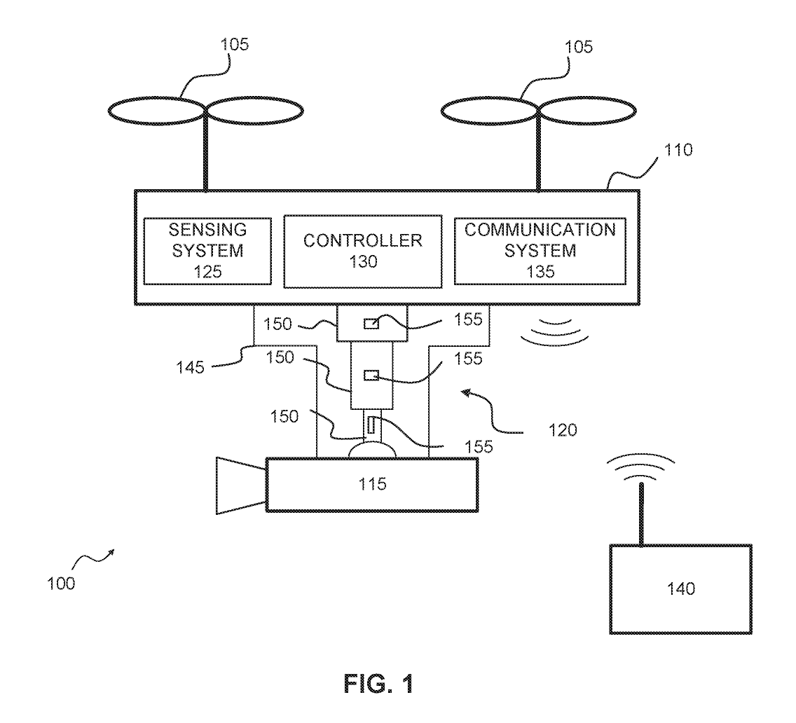

FIG. 1 illustrates an exemplary movable object 100 that may be configured to move or travel within an environment (e.g., surroundings). Movable object Error! Reference source not found. 100 may be any suitable object, device, mechanism, system, or machine configured to travel on or within a suitable medium (e.g., a surface, air, water, rails, space, underground, etc.). For example, movable object 100 may be an unmanned aerial vehicle (UAV). Although movable object 100 is shown and described herein as a UAV for illustrative purposes, it is understood that other types of movable object (e.g., wheeled objects, nautical objects, locomotive objects, other aerial objects, etc.) may also or alternatively be used in embodiments consistent with this disclosure. As used herein, the term UAV may refer to an aerial device configured to be operated and/or controlled automatically (e.g., via an electronic control system) and/or manually by off-board personnel.

As shown in FIG. 1, movable object 100 may include one or more propulsion devices 105 connected to a main body 110. Movable object 100 may be configured to carry a payload 115. Payload 115 may be connected or attached to movable object 100 by a carrier 120, which may allow for one or more degrees of relative movement between payload 115 and main body 110. In some embodiments, payload 115 may be mounted directly to main body 110 without carrier 120.

Movable object 100 may also include a sensing system 125 including one or more sensors configured to measure data relating to operations (e.g., motions) of movable object 100 and/or the environment in which movable object 100 is located. Movable object 100 may also include a controller 130 in communication with various sensors and/or devices onboard movable object 100. Controller 130 may be configured to control such sensors and devices.

Movable object 100 may also include a communication system 135 configured to enable communication between movable object 100 and another device external to movable object 100. In some embodiments, communication system 135 may also enable communication between various devices and components included in movable object 100 or attached to movable object 100.

As shown in FIG. 1, one or more propulsion devices 105 may be positioned at various locations (e.g., top, sides, front, rear, and/or bottom of main body 110) for propelling and steering movable object 100. Any suitable number of propulsion devices 105 may be included in movable object 100, such as one, two, three, four, six, eight, ten, etc. Propulsion devices 105 may be in communication with controller 130 and may be controlled by controller 130.

Propulsion devices 105 may include devices or systems operable to generate forces for sustaining controlled flight. Propulsion devices 105 may be operatively connected to a power source (not shown), such as a motor (e.g., an electric motor, hydraulic motor, pneumatic motor, etc.), an engine (e.g., an internal combustion engine, a turbine engine, etc.), a battery, etc., or combinations thereof.

In some embodiments, propulsion devices 105 may also include one or more rotary components (e.g., rotors, propellers, blades, nozzles, etc.) drivably connected to the power source and configured to generate forces for sustaining controlled flight. Rotary components may be driven by a shaft, axle, wheel, hydraulic system, pneumatic system, or other component or system configured to transfer power from the power source. Propulsion devices 105 and/or rotary components may be adjustable (e.g., tiltable, foldable, collapsible) with respect to each other and/or with respect to main body 110. Controller 130 may control the rotational speed and/or tilt angle of propulsion devices. Alternatively, propulsion devices 105 and the rotary components may have a fixed orientation with respect to each other and/or main body 110.

In some embodiments, each propulsion device 105 may be of the same type. In other embodiments, propulsion devices 105 may be of different types. In some embodiments, all propulsion devices 105 may be controlled in concert (e.g., all at the same speed and/or angle). In other embodiments, one or more propulsion devices may be independently controlled such that not all of propulsion devices 105 share the same speed and/or angle.

Propulsion devices 105 may be configured to propel movable object 100 in one or more vertical and horizontal directions and to allow movable object 100 to rotate about one or more axes. That is, propulsion devices 105 may be configured to provide lift and/or thrust for creating and maintaining translational and rotational movements of movable object 100. For example, propulsion devices 105 may be configured to enable movable object 100 to achieve and maintain desired altitudes, provide thrust for movement in various directions, and provide for steering of movable object 100. In some embodiments, propulsion devices 105 may enable movable object 100 to perform vertical takeoffs and landings (i.e., takeoff and landing without horizontal thrust). In other embodiments, movable object 100 may require constant minimum horizontal thrust to achieve and sustain flight. Propulsion devices 105 may be configured to enable movement of movable object 100 along and/or about multiple axes.

Payload 115 may include one or more sensory devices, which may include devices for collecting or generating data or information, such as surveying, tracking, and capturing images or video of targets (e.g., objects, landscapes, subjects of photo or video shoots, etc.). Payload 115 may include imaging devices configured to generate images. For example, imaging devices may include photographic cameras, video cameras, infrared imaging devices, ultraviolet imaging devices, x-ray devices, ultrasonic imaging devices, radar devices, laser devices, etc. Payload 115 may also, or alternatively, include devices for capturing audio data, such as microphones or ultrasound detectors. Payload 115 may also or alternatively include other suitable sensors for capturing visual, audio, and/or electromagnetic signals.

Carrier 120 may include one or more devices configured to support (e.g., by holding) the payload 115 and/or allow the payload 115 to be adjusted (e.g., rotated) with respect to main body 110. For example, carrier 120 may be a gimbal. Carrier 120 may be configured to allow payload 115 to be rotated about one or more axes, as described below. In some embodiments, carrier 120 may be configured to allow 360° rotations about each axis to allow for greater control of the perspective of the payload 115. In other embodiments, carrier 120 may limit the range of rotation of payload 115 to less than 360° (e.g., less than 270°, 210°, 180°, 120°, 90°, 45°, 30°, 15°, etc.) about one or more axes.

Carrier 120 may include a frame assembly 145, one or more actuator members 150, and one or more carrier sensors 155. Frame assembly 145 may be configured to couple payload 115 to main body 110. In some embodiments, frame assembly 145 may allow payload 115 to move with respect to main body 110. In some embodiments, frame assembly 145 may include one or more sub-frames or components movable with respect to each other.

Actuator members 150 may be configured to drive components of frame assembly relative to each other to provide translational and/or rotational motion of payload 115 with respect to main body 110. In some embodiments, actuator members 150 may be configured to directly act on payload 115 to cause motion of payload 115 with respect to frame assembly 145 and main body 110. Actuator members 150 may include electric motors configured to provide linear and/or rotational motions to components of frame assembly 145 and/or payload 115 in conjunction with axles, shafts, rails, belts, chains, gears, and/or other components.

Carrier sensors 155 may include devices configured to measure, sense, detect, or determine state information of carrier 120 and/or payload 115. State information may include positional information (e.g., relative location, orientation, attitude, linear displacement, angular displacement, etc.), velocity information (e.g., linear velocity, angular velocity, etc.), acceleration information (e.g., linear acceleration, angular acceleration, etc.), and or other information relating to movement control of carrier 120 or payload 115 with respect to main body 110. Carrier sensors 155 may include one or more potentiometers, optical sensors, visions sensors, magnetic sensors, and motion or rotation sensors (e.g., gyroscopes, accelerometers, inertial sensors, etc.).

Carrier sensors 155 may be associated with or attached to various components of carrier 120, such as components of frame assembly 145, actuator members 150, or main body 110. Carrier sensors 155 may be configured to communicate data to, and/or receive data from, controller 130 via a wired or wireless connection (e.g., RFID, Bluetooth, Wi-Fi, radio, cellular, etc.), which may be part of communication system 135 or may be separately provided for internal communication within movable object 100. Data generated by carrier sensors 155 and communicated to controller 130 may be further processed by controller 130. For example, controller 130 may determine state information of movable object 100.

Carrier 120 may be coupled to main body 110 via one or more damping elements configured to reduce or eliminate undesired shock or other force transmissions to payload 115 from main body 110. Damping elements may be active, passive, or hybrid (i.e., having active and passive characteristics). Damping elements may include any suitable material or combinations of materials, including solids, liquids, and gases. Compressible or deformable materials, such as rubber, springs, gels, foams, and/or other materials may be used as damping elements. The damping elements may function to isolate and/or dissipate force propagations from main body 110 to payload 115. Damping elements may also include mechanisms or devices configured to provide damping effects, such as pistons, springs, hydraulics, pneumatics, dashpots, shock absorbers, and/or other devices or combinations thereof.

Sensing system 125 may include one or more sensors associated with one or more components or other systems of movable device 100. For example, sensing system 125 may include sensors configured to measure positional information, velocity information, and acceleration information relating to movable object 100 and/or the environment in which movable object 100 is located. The sensors included in sensing system 125 may be disposed at various locations on movable object 100, including main body 110, carrier 120, and payload 115. In some embodiments, sensing system 125 may include carrier sensors 155.

Components of sensing system 125 may be configured to generate data that may be used (e.g., processed by controller 130 or another device) to derive additional information about movable object 100, its components, or the environment in which movable object 100 is located. Sensing system 125 may include one or more sensors for sensing one or more aspects of movement of movable object 100. For example, sensing system 125 may include sensory devices associated with payload 115 as discussed above and/or additional sensory devices, such as a receiver for a positioning system (e.g., GPS, GLONASS, Galileo, Beidou, GAGAN, etc.), motion sensors, inertial sensors (e.g., Inertial Measurement Unit (IMU) sensors), proximity sensors, image sensors, etc.

Sensing system 125 may be configured to provide data or information relating to the surrounding environment, such as weather information (e.g., temperature, pressure, humidity, etc.), lighting conditions, air constituents, or nearby obstacles (e.g., objects, structures, people, other vehicles, etc.). In some embodiments, sensing system 125 may include an image sensor (e.g., a camera) configured to capture an image, which may be processed by controller 130 for detecting an object in the flight path of movable object 100. Other sensors may also be included in sensing system 125 for detecting an object (e.g., an obstacle) in the flight path of movable object 100. Such sensors may include, for example, at least one of a radar sensor, a laser sensor, an infrared sensor, a stereo vision system having at least two cameras, an ultrasonic sensor, and a time-of-flight sensor.

Controller 130 may be configured to receive data from various sensors and/or devices included in movable object 100 and/or external to movable object 100. Controller 130 may receive the data via communication system 135. For example, controller 130 may receive user input for controlling the operation of movable object 100 via communication system 135. In some embodiments, controller 130 may receive data measured by sensing system 125. Controller 130 may analyze or process received data and produce outputs to control propulsion devices 105, payload 115, etc., or to provide data to sensing system 125, communication system 135, etc.

Controller 130 may include a computing device, such as one or more processors configured to process data, signals, and/or information received from other devices and/or sensors. Controller 130 may also include a memory or any other suitable nontransitory or transitory computer-readable storage media, such as hard disk, optical discs, magnetic tapes, etc. In some embodiments, the memory may store instructions or code to be executed by the one or more processors for performing various methods and processes disclosed herein or for performing various tasks. Controller 130 may include hardware, software, or both. For example, controller 130 (e.g., the processors and/or memory) may include hardware components such as application specific integrated circuits, switches, gates, etc., configured to process inputs and generate outputs.

Communication system 135 may be configured to enable communications of data, information, commands, and/or other types of signals between controller 130 and other devices, such as sensors and devices on-board movable object 100. Communication system 135 may also be configured to enable communications between controller 130 and off-board devices, such as a terminal 140, a positioning device (e.g., a Global Positioning System satellite), another movable object 100, etc.

Communication system 135 may include one or more components configured to send and/or receive signals, such as receivers, transmitters, or transceivers that are configured to carry out one- or multiple-way communication. For example, communication system 135 may include one or more antennas. Components of communication system 135 may be configured to communicate with off-board devices or entities via one or more communication networks. For example, communication system 135 may be configured to enable communications between devices for providing input for controlling movable object 100 during flight, such as terminal 140.

In some embodiments, communication system 135 may utilize one or more of local area networks (LAN), wide area networks (WAN), infrared, radio, Wi-Fi, point-to-point (P2P) networks, cellular networks, cloud communication, and the like. Optionally, relay stations, such as towers, satellites, or mobile stations, may be used by communication system 135. Wireless communications may be proximity dependent or proximity independent. In some embodiments, line-of-sight may or may not be required for communications.

Terminal (or control terminal) 140 may be configured to receive input, such as input from a user (i.e., user input), and communicate signals indicative of the input to controller 130. Terminal 140 may be configured to receive user input (e.g., from an operator) and generate corresponding signals, such as control data (e.g., signals) for operating or manipulating movable device 100 (e.g., via propulsion devices 105), payload 115, sensing system 125, and/or carrier 120. Terminal 140 may also be configured to receive data from movable object 100, such as operational data relating to positional data, velocity data, acceleration data, sensory data, and/or other data relating to components and/or the surrounding environment.

In some embodiments, terminal 140 may be a dedicated remote control with physical joysticks, buttons, or a touch screen configured to receive an input from a user. In some embodiments, terminal 140 may also be a smartphone, a tablet, and/or a computer that includes physical and/or virtual controls (e.g., virtual joysticks, buttons, user interfaces) for receiving a user input for controlling movable object 100. In some embodiments, terminal 140 may include a device configured to transmit information about its position or movement. For example, terminal 140 may include a positioning system data receiver configured to receive positioning data from a positioning system. Terminal 140 may include sensors configured to detect movement or angular acceleration, such as accelerometers or gyros. Terminal 140 may communicate data to a user or other remote system, and receive data from the user or other remote system.

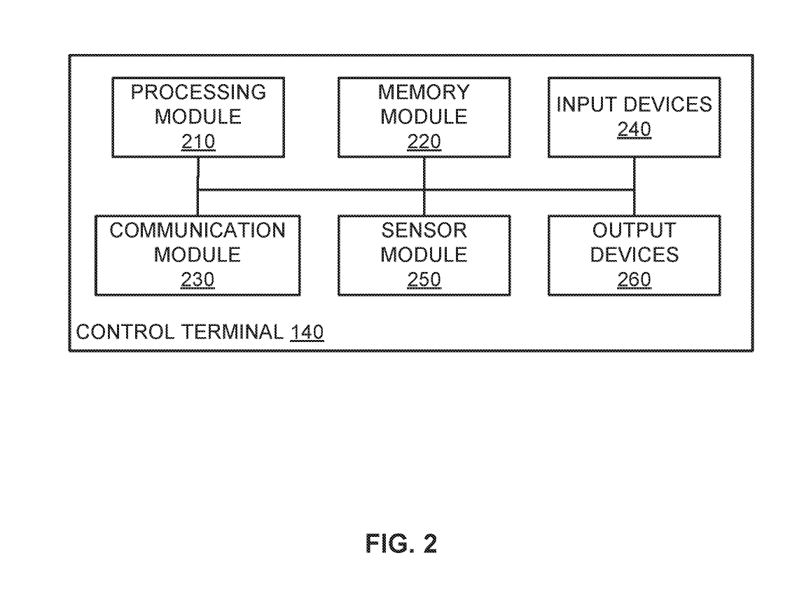

FIG. 2 schematically illustrates an exemplary structure of control terminal 140. Terminal 140 may include a processing module 210, a memory module 220, a communication module 230, input devices 240, a sensor module 250, and output devices 260.

Processing module 210 may be configured to execute computer-executable instructions stored in memory module 220 to perform various methods and processes related to operations and/or controls of movable object 100. Processing module 210 may include hardware components, software components, or both. For example, processing module 210 may include one or more processors configured to process data received from other devices and/or sensors of movable object 100, and/or data received from a device external to movable object 100.

In some embodiments, processing module 210 may include a microprocessor, graphics processors such as an image preprocessor, a central processing unit (CPU), support circuits, digital signal processors, integrated circuits, memory, or any other types of devices suitable for running applications and for data and/or signal processing and analysis. In some embodiments, processing module 210 may include any type of single or multi-core processor, mobile device microcontroller, etc. In a multi-processing system, multiple processing units or processors may execute computer-executable instructions to increase processing power.

Memory module 220 may include a volatile memory (e.g., registers, cache, RAM), a non-volatile memory (e.g., ROM, EEPROM, flash memory, etc.), or a combination thereof. The memory may store software implementing computer applications (e.g., apps) for terminal 140. For example, the memory may store an operating system, software implementing transmission of data from the terminal 140 to a remote device, such as movable object 100. Typically, operating system software provides an operating environment for other software executing in the computing environment, and coordinates activities of the components of the computing environment.

Communication module 230 may be configured to facilitate communication of information between terminal 140 and other entities, such as movable object 100. In some embodiments, communication module 230 may facilitate communication with movable object 100 via communication system 135 included in movable object 100. Communication module 230 may include antennae or other devices configured to send and/or receive signals.

Terminal 140 may include one or more input devices 240 configured to receive input from a user and/or a sensor module 250 included or connected to terminal 140. In some embodiments, input devices 240 may be configured to receive user inputs indicative of desired movements (e.g., flight path) of movable object 100 or user inputs for controlling devices or sensors included in movable object 100. Input devices 240 may include one or more input levers, buttons, triggers, etc. Input devices 240 may be configured to generate a signal to communicate to movable object 100 using communication module 230. In addition to movement control inputs, input devices 240 may be used to receive other information, such as manual control settings, automated control settings, control assistance settings.

Output devices 260 may be configured to display information to a user or output data to another device external to terminal 140. In some embodiments, output devices 260 may include a multifunctional display device configured to display information on a multifunctional screen as well as to receive user input via the multifunctional screen (e.g., touch input). Thus, output devices 260 may also function as input devices. In some embodiments, a multifunctional screen may constitute a sole input device for receiving user input and output device for outputting (e.g., displaying) information to the user.

In some embodiments, terminal 140 may include an interactive graphical interface configured for receiving one or more user inputs. The interactive graphical interface may be displayable on output devices 260, and may include graphical features such as graphical buttons, text boxes, dropdown menus, interactive images, etc. For example, in one embodiment, terminal 140 may include graphical representations of input levers, buttons, and triggers, which may be displayed on and configured to receive user input via a multifunctional screen. In some embodiments, terminal 140 may be configured to generate graphical versions of input devices 240 in conjunction with an application (or “app”) to provide an interactive interface on the display device of any suitable electronic device (e.g., a cellular phone, a tablet, etc.) for receiving user inputs.

In some embodiments, output devices 260 may be an integral component of terminal 140. In other embodiments, output devices 260 may be connectable to (and detachable from) terminal 140.

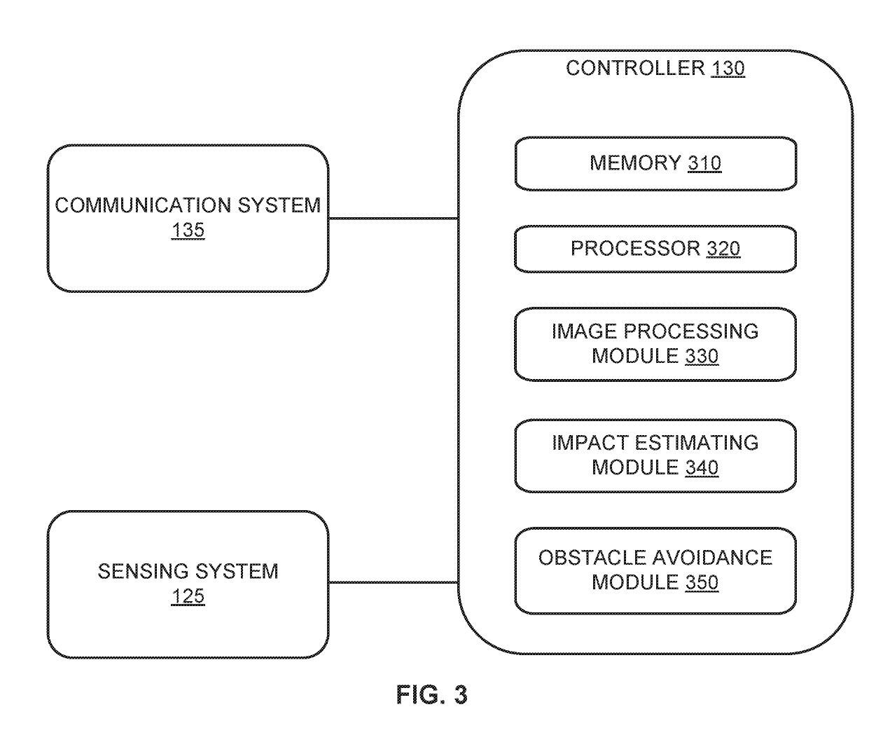

FIG. 3 schematically illustrates an exemplary structure of controller 130. As shown in FIG. 3, controller 130 may include a memory 310, at least one processor 320 (e.g., one or more processors 320), an image processing module 330, an impact estimating module 340, and obstacle avoidance module 350. Each module may be implemented as software comprising code or instructions, which when executed by processor 320, causes processor 320 to perform various methods or processes. Additionally or alternatively, each module may include its own processor (e.g., a processor that is similar to processor 320) and software code. For convenience of discussion, a module may be described as being configured to perform a method, although it is understood that in some embodiments, it is processor 320 that executes code or instructions stored in that module to perform the method.

Memory 310 may be or include non-transitory computer-readable medium and can include one or more memory units of non-transitory computer-readable medium. Non-transitory computer-readable medium of memory 310 may include any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Memory units may include permanent and/or removable portions of non-transitory computer-readable medium (e.g., removable media or external storage, such as an SD card, RAM, etc.).

Memory 310 may store data acquired from sensing system 125. Sensing system 125 may be an embodiment of sensing system 125 shown in FIG. 1, and may include similar or the same components as sensing system 125. Memory 310 may also be configured to store logic, code and/or program instructions executable by processor 320 to perform any suitable embodiments of the methods described herein. For example, memory 310 may be configured to store computer-readable instructions that, when executed by processor 320, cause the processor to perform a method for detecting an object in a flight path of movable object 100, and/or a method for avoiding the object in the flight path. In some embodiments, memory 310 can be used to store the processing results produced by processor 320.

Processor 320 may include one or more processor devices or processors and may execute computer-executable instructions stored in memory 310. Processor 320 may be a physical processor device or a virtual processor device. In a multi-processing system, multiple processing units or processors may execute computer-executable instructions to increase processing power. Processor 320 may include a programmable processor (e.g., a central processing unit (CPU)). Processor 320 may be operatively coupled to memory 310 or another memory device. In some embodiments, processor 320 may include and/or alternatively be operatively coupled to one or more control modules shown in FIG. 3.

Processor 320 may be operatively coupled to communication system 135 and communicate with other devices via communication system 135. For example, processor 320 may be configured to transmit and/or receive data from one or more external devices (e.g., terminal 140 or other remote controllers) via communication system 135.

The components of controller 130 may be arranged in any suitable configuration. For example, controller 130 may be distributed in different portions of movable object 100, e.g., main body 110, carrier 120, payload 115, sensing system 125, or an additional external device in communication with movable object 100 such as terminal 140. In some embodiments, one or more processors or memory devices may be included in movable object 100.

Image processing module 330 may be configured to process images acquired by sensing system 125. For example, sensing system 125 may include one or more image sensors (e.g., one or more cameras) configured to capture an image of an environment or a scene in which movable object 100 is located. The image may include one or more objects. Image processing module 330 may utilize image recognition methods, machine vision, and any other suitable image processing methods to analyze the image. For example, image processing module 330 may process the image to obtain depth information of pixels included in the image. In some embodiments, image processing module 330 may implement a suitable algorithm to rectify a plurality of images obtained using two or more cameras before obtaining depth information. Image processing module 330 may process the image to generate a depth map. Image processing module 330 may obtain the depth information of the pixels included in the image using a depth map. In some embodiments, image processing module 330 may generate a plurality of depth layers based on the image, each depth layer may include pixels of the image having the same depth or having depths within a predetermined range.

Image processing module 330 may include hardware components, software components, or a combination thereof. For example, image processing module 330 may include hardware components such as integrated circuits, gates, switches, etc. Image processing module 330 may include software code or instructions that may be executed by processor 320 for performing various image processing methods.

Impact estimating module 340 may be configured to estimate an impact of an object on the travel of movable object 100. Impact estimating module 340 may analyze data received from sensing system 125 and/or from an external source through communication system 135 to determine whether an object is going to have an impact on the travel of movable object 100. Data received from sensing system 125 may include data sensed by an image sensor (e.g., a stereo vision system), a radar sensor, a laser sensor, an infrared sensor, an ultrasonic sensor, a time-of-flight sensor, or a combination thereof. Although impact estimating module 340 may be described as using image data, it is understood that other data from other types of sensors may also be used.

Impact estimating module 340 may analyze images obtained by one or more cameras and processed by image processing module 330. For example, impact estimating module 340 may receive data (e.g., depth information) from image processing module 330. Impact estimating module 340 may determine if an object falls in a safety zone and becomes an obstacle. The safety zone may be defined by a flying tunnel and/or a crash tunnel, which are described in greater detail below.

Impact estimating module 340 may determine the impact of an object based on projection of the flying tunnel and/or crash tunnel onto different depth layers. Impact estimating module 340 may determine that the object is an obstacle in the travel path of movable object 100 and may pose a threat to the safe movement of movable object 100. For a depth layer associated with a certain depth, impact estimating module 340 may determine whether an object exists within the safety zone based on a total number of pixels of the object within a flying tunnel and/or crash tunnel. When the total the number of pixels is greater than a predetermined threshold, impact estimating module 340 may determine that the object is detected within the safety zone of movable object 100. Impact estimating module 340 may send a signal or data to obstacle avoidance module 350 such that obstacle avoidance module 350 may determine a suitable travel path for movable object 100.

In some embodiments, impact estimating module 340 may determine that movable object 100 may collide with an object and/or whether the object may get too close to find a way around the object. For example, when movable object 100 approaches a large object such as a building, the image of the building may occupy a large percentage (e.g., a predetermined percentage such as 60%, 70%, 80%, 90%, or 100%) of the image frame of the camera. This may make it difficult for movable object 100 to find a way around the large object based on captured images.

Based on a determination of whether the object would occupy a large percentage of the image frame (e.g., of the depth image or depth layer) in a certain amount of time, impact estimating module 340 may determine whether the object is a large object or a regular object. A large object is one that may occupy a large percentage of the image frame of a camera when movable object 100 is within a certain distance to the object. Examples of a large object include a building, a tower, a tree, a mountain, etc. Any objects that are not large objects may be treated as regular objects.

Travel path adjustments for avoiding large objects and regular objects may be different. It is understood that an object having a large size in the physical world may not necessarily be treated as a large object from the perspective of the movable object. For example, when the object of a large size is not within the travel path or has only a small portion within the travel path (which may not occupy a large percentage of the image frame when the movable object is close to the object), the object having a large size may not be treated as a large object by movable object 100.

In some embodiments, impact estimating module 340 may detect a wall and/or a ground in the image. Impact estimating module 340 may determine that the wall and/or ground do not pose a threat to movable object 100 if movable object 100 travels in parallel (or substantially in parallel) with the wall and/or ground while maintaining a safe distance to the wall and/or ground. In such circumstances, movable object 100 may not treat the wall and/or ground as obstacles and may not completely stop moving. Instead, movable object 100 may continue travel in parallel (or substantially in parallel) with the wall and/or ground while maintaining a predetermined safe distance to the wall and/or ground.

Impact estimating module 340 may include hardware components, software components, or a combination thereof. For example, impact estimating module 340 may include hardware components such as integrated circuits, gates, switches, etc. Impact estimating module 340 may include software code or instructions that may be executed by processor 320 for performing various impact estimating processes.

Obstacle avoidance module 350 may be configured to alter moving parameters of movable object 100 to adjust the travel path. For example, obstacle avoidance module 350 may control propulsion devices 105 of movable object 100 to adjust the rotating speed and/or angle, thereby changing the travel path to avoid the detected object. When an object is detected within a safety zone of movable object 100, obstacle avoidance module 350 may receive a signal or data from impact estimating module 340 indicating that an object has been detected, and the travel path should be adjusted to avoid the object. In some embodiments, the signal or data received from impact estimating module 340 may also indicate whether the object is a large object or a regular object, or whether a wall and/or a ground is detected.

Obstacle avoidance module 350 may adjust the travel path of movable object 100 in different ways to avoid large objects and regular objects. For example, when a regular object is detected, obstacle avoidance module 350 may adjust the travel path to travel around the object as movable object 100 moves near the object within a predetermined distance, such as 1 meter, 5 meters, 10 meters, etc. The predetermined distance may be pre-programmed in controller 130, or dynamically determined by controller 130 based on the detected object and/or the current speed of movable object 100. As movable object 100 travels near the detected regular object, in one embodiment, obstacle avoidance module 350 may emulate a repulsive field and impose the repulsive field on at least one of the velocity field or the acceleration field of movable object 100. The repulsive field may include velocity and/or acceleration parameters, which when combined with the current velocity and/or acceleration of movable object 100, causing movable object 100 to travel in an altered travel path that avoids (e.g., travels around) the detected object. The adjusted travel path represents a smooth travel path for movable object 100, which does not include an abrupt stop or a sharp turn.

When a large object is detected within the safety zone as movable object 100 moves, obstacle avoidance module 350 may adjust the travel path in advance before movable object 100 gets too close to the large object. For example, when impact estimating module 340 determines or estimates that movable object 100 would get too close to a building (a large object) in 5 minutes from the current position of movable object 100, such that the building would occupy 90% of the image frame, obstacle avoidance module 350 may adjust the travel path 2 minutes before the end of the 5 minutes, such that movable object 100 can travel along the adjusted travel path to avoid getting too close to building. Obstacle avoidance module 350 may adjust the travel path to include a smooth portion that goes around the building.

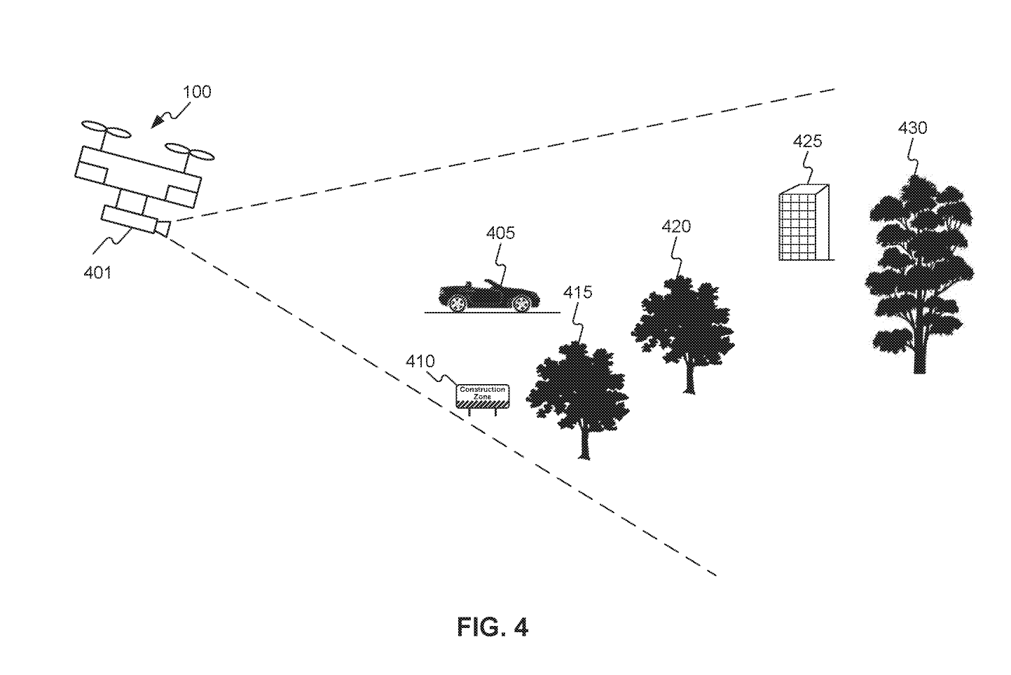

FIG. 4 illustrates an exemplary method for identifying an object as an obstacle and avoiding the obstacle. Movable object 100 may travel in an automatic mode or a manual mode with user input received from terminal 140.

For illustrative purposes, in the following discussion of exemplary methods in connection with FIG. 4, an image sensor 401 is assumed to be used with movable object 100. Image sensor 401 may be located at where payload 115 is located, or may be located at any other locations on movable object 100. Image sensor 401 may be configured to capture one or more images of the environment as movable object 100 moves. The images may include one or more objects. For convenience of discussion, image sensor 401 may also be referred to as a camera 401.

The environment of movable object 100 may include various objects. For example, the environment may include a vehicle 405, a road construction sign 410, a first tree 415, a second tree 420, a building 425, and a third tree 430. Other objects, although not shown, may also be in the environment, such as a mountain, a tower, another movable object, etc.

The objects shown in FIG. 4 may be located at different distances from movable object 100. The different distances are reflected in images as different depths. Each pixel in an image may have a depth. Pixels of different objects in the same image may have different depths.

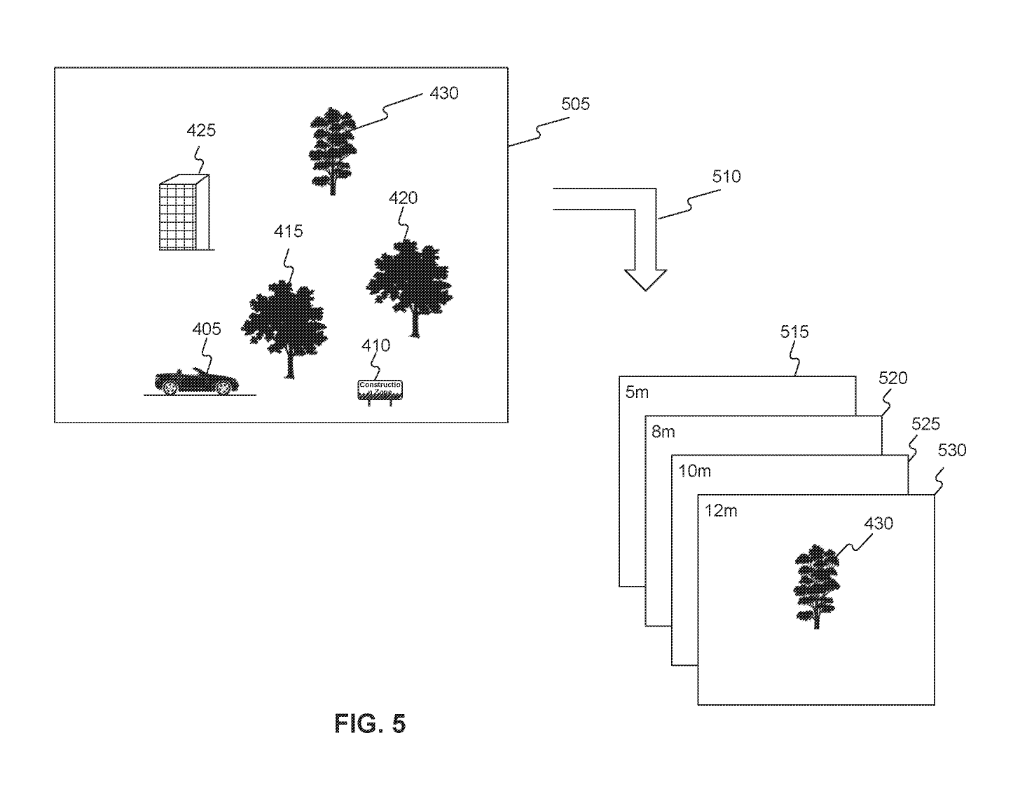

FIG. 5 illustrates an exemplary process for generating a plurality of depth layers from one or more images. Image 505 captured by image sensor 401 may include various objects from the environment. An image processing method 510 may be performed to analyze image 505. Image processing method 510 may be performed by image processing module 330, processor 320, or a combination thereof. Image processing method 510 may obtain depth information of the pixels of image 505 using methods known in the industry, such as stereo vision processing. A plurality of depth images or depth layers 515-530 in the depth space may be generated based on the depth information of the pixels. Each depth layer may include pixels having the same depth or depths within a predetermined range. For illustrative purposes only, words (“5 m,” “8 m,” “10 m,” and “12 m”) representing depths associated with each depth layer are shown on each depth layer. Actual depth layers include pixels and data relating to the depth information of the pixels.

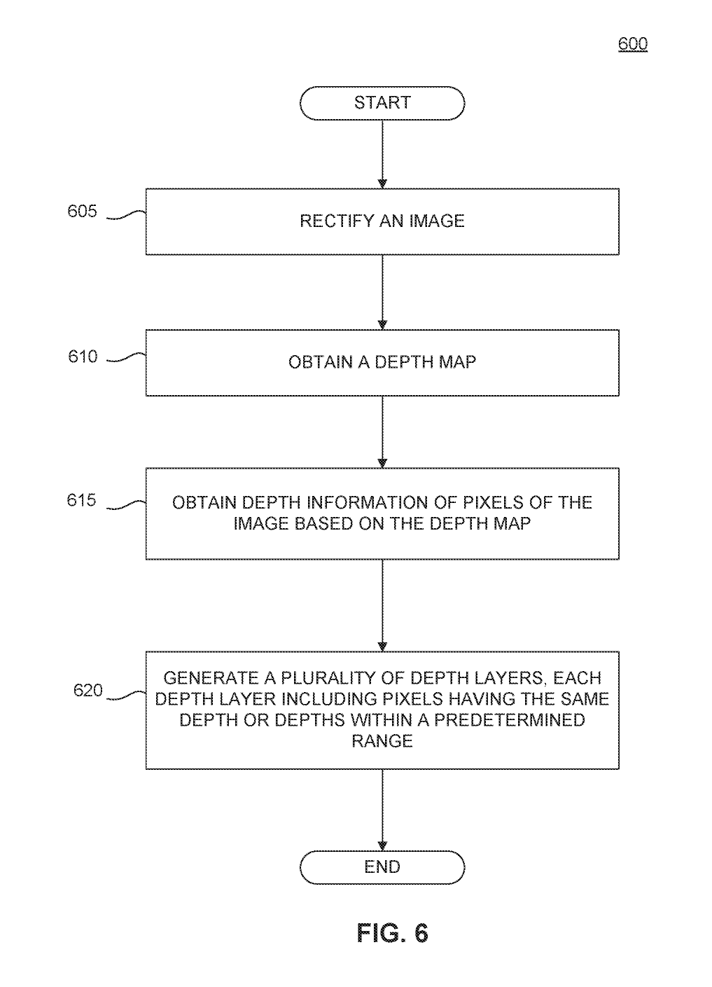

FIG. 6 is a flowchart illustrating an exemplary method for processing an image to obtain depth information. Method 600 may be an embodiment of image processing method 510 shown in FIG. 5. Method 600 may be performed by image processing module 330, processor 320, or a combination thereof. Method 600 may include rectifying an image (e.g., image 505 shown in FIG. 5) (step 605). Any suitable algorithms may be used to rectify the image, such as planar rectification, cylindrical rectification, and polar rectification.

Method 600 may include obtaining a depth map of the image (step 610) and may also include an image rectification step before generating the depth map. The depth map may be obtained using any method known in the art.

Method 600 may also include obtaining depth information of pixels of the image based on the depth map (step 615). A depth Dₓ in an x direction (e.g., a travel direction of movable object 100) of a pixel may be determined based on the following formula:

$${D}_{x} = \frac{{D}_{depth}}{cos ( θ )} \qquad ( 1 )$$

In formula (1), D_{depth} is data from the depth map, θ=θ₁+θ₂, where θ₁ is the pitch angle of camera 401 relative to an inertial measurement unit (IMU) included in movable object 100, and θ₂ is the pitch angle of the IMU to ground. Angles θ₁ and θ₂ may be obtained by sensors included in movable object 100. Each pixel of the image may have a depth.

For example, for the objects 405-430 shown in FIG. 5, some or all of the pixels of vehicle 405 may have the same depth of 5 meters or have depths within a predetermined range of 5 meters (e.g., 4.85 meters to 5.15 meters). Some or all of the pixels of road construction sign 410 may have the same depth of 5 meters or have depths within a predetermined range of 5 meters (e.g., 4.85 meters to 5.15 meters). Some or all of the pixels of first tree 415 may have the same depth of 5 meters or have depths within a predetermined range of 5 meters (e.g., 4.85 meters to 5.15 meters).

Some or all of the pixels of second tree 420 may have the same depth of 8 meters or have depths within a predetermined range of 8 meters (e.g., 7.85 meters to 8.15 meters). Some or all of the pixels of building 425 may have the same depth of 10 meters or have depths within a predetermined range of 10 meters (e.g., 9.85 meters to 10.15 meters). Some or all of the pixels of third tree 430 may have the same depth of 12 meters or have depths within a predetermined range of 12 meters (e.g., 11.85 meters to 12.15 meters).

Referring back to FIG. 6, method 600 may include generating a plurality of depth layers, each depth layer including pixels having the same depth or depths within a predetermined range (step 620). For example, as shown in FIG. 5, a first depth layer 515 may be generated to include pixels having a depth of 5 meters (or having depths within a predetermined range around 5 meters, as described above, or having an average depth of 5 meters). First depth layer 520 may include, for example, some or all of the pixels of vehicle 405, road construction sign 410, and first tree 415. A second depth layer 520 may be generated to include pixels having a depth of 8 meters (or having depths within a predetermined range around 8 meters, as described above, or having an average depth of 8 meters). Second depth layer 520 may include some or all of the pixels of second tree 420. A third depth layer 525 may be generated to include pixels having a depth of 10 meters (or having depths within a predetermined range around 10 meters, as described above, or having an average depth of 10 meters). Third depth layer 525 may include some or all of the pixels of building 425. A fourth depth layer 530 may be generated to include pixels having a depth of 12 meters (or having depths within a predetermined range around 12 meters, as described above, or having an average depth of 12 meters). Fourth depth layer 530 may include some or all of the pixels of third tree 430.

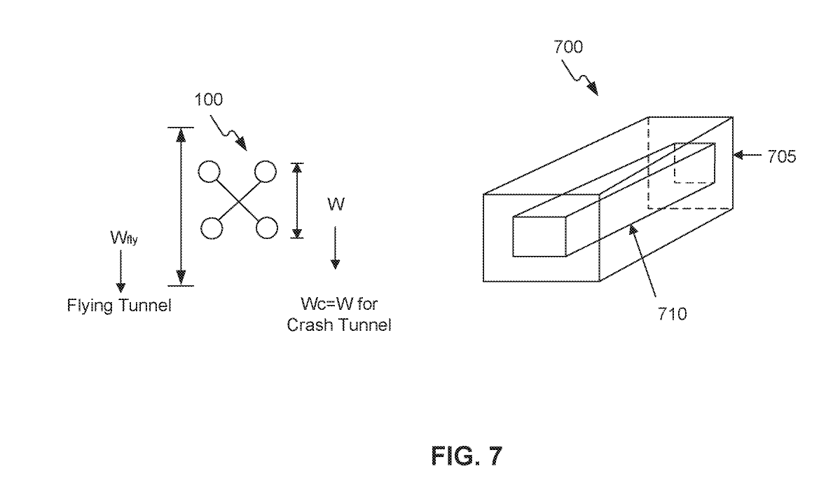

FIG. 7 illustrates an exemplary safety zone of a movable object. As described above, safety zone 700 may be any virtual three-dimensional space that defines a safe travel zone for movable object 100. For example, as shown in FIG. 7, safety zone 700 may be defined as a flying tunnel 705, a crash tunnel 710, or both. Flying tunnel 705 and crash tunnel 710 may be virtual projections from the movable object in the travel direction along the travel path (e.g., in the direction of the current velocity). Flying tunnel 705 and crash tunnel 710 may have cross sections of any suitable shapes, such as cubical shapes, as shown in FIG. 7, oval shapes, circular shapes, triangular shapes, etc. The cross sections of flying tunnel 705 and crash tunnel 710 may have the same shapes or different shapes.

The sizes of flying tunnel 705 and crash tunnel 710 may be determined based on a size of movable object 100, as well as characteristics of its movement. A schematic illustration of a top view of movable object 100 is shown in FIG. 7. A width of movable object 100 in the travel direction may be denoted as W, and a height of movable object may be denoted as H (not shown). The width W_{c} of crash tunnel 710 may be the same as the width W of movable object 100, as indicated in FIG. 7. The height of crash tunnel 710 may also be the same as the height of movable object 100. Crash tunnel 710 represents a space in which a collision with an object (if exists within the crash tunnel) may occur. In some embodiments, it is possible to define the width and height of crash tunnel 710 to be slightly smaller or larger than the width and height of movable object 100.

The width W_{fly} of flying tunnel 705 may be larger than the width W of movable object 100, as shown in FIG. 7. The height of flying tunnel 705 may also be larger than the height H of movable object 100. The width and height of flying tunnel 705 may be adjustable depending on specific operation of movable object 100 and the environment in which it travels. In some embodiments, the width and height of flying tunnel 705 may be dynamically adjusted while movable object 100 travels in the environment. For example, movable object 100 may adjust, e.g., through controller 130, the width and height of flying tunnel 705 based on the current speed of movable object 100. For example, flying tunnel 705 may be enlarged when the speed is increased, and reduced when the speed is reduced. In some embodiments, the size of flying tunnel 705 may be pre-programmed and may not be adjusted during flight.

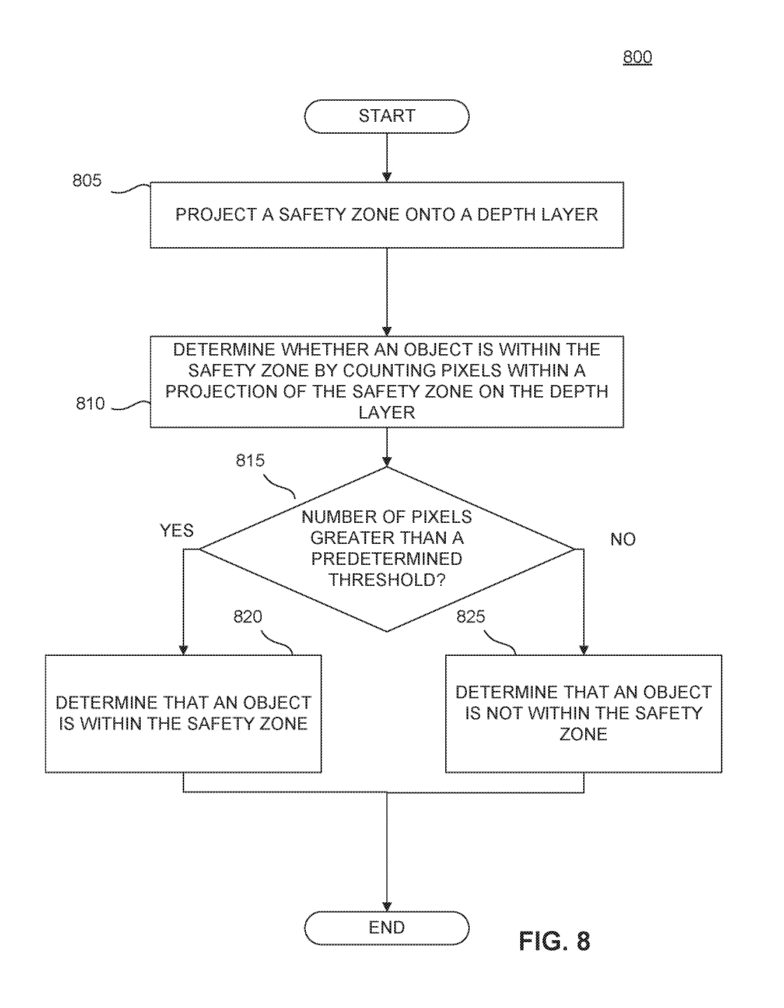

FIG. 8 is a flowchart illustrating an exemplary method for detecting an object in a safety zone of a movable object. Method 800 may be performed by impact estimating module 340, processor 320, or a combination thereof. Method 800 may be performed after method 600 has been performed. Method 800 may be applied to any or all of depth layers 515-530 to determine whether an object is within the safety zone projected onto the depth layers. In some embodiments, method 800 may be applied to the depth layers starting with the depth layer having the smallest depth (objects included in the depth layer may be closest to movable object 100 in the physical world).

Method 800 may include projecting a safety zone onto a depth layer (step 805), such as one of depth layers 515-530 (shown in FIG. 5) generated in step 620 of method 600 (shown in FIG. 6). The safety zone may be defined by the flying tunnel and/or the crash tunnel, as described above and shown in FIG. 7. Projecting the safety zone onto a depth layer may include projecting at least one of the flying tunnel or the crash tunnel onto the depth layer. In some embodiments, projecting the safety zone onto the depth layer may include projecting both the flying tunnel and the crash tunnel onto the depth layer.

Method 800 may also include determining whether an object is within the safety zone by counting pixels within a projection of the safety zone on the depth layer (step 810). For example, counting pixels within the projection of the safety zone may include counting a total number of pixels within a projection of the flying tunnel and/or the crash tunnel on the depth layer. Method 800 may include determining whether the total number of pixels counted in step 810 is greater than a predetermined threshold (step 815). The predetermined threshold may be any suitable number, such as 10 pixels, 20 pixels, etc. When both the flying tunnel and the crash tunnel are projected onto a depth layer, in one embodiment, a first number of pixels in a projection of the flying tunnel may be counted, and a second number of pixels in a projection of the crash tunnel may be counted. Various methods may be used to calculate the total number of pixels in the flying tunnel and the crash tunnel. For example, in one embodiment, the total number of pixels may be the direct sum of the first number and the second number. In another embodiment, the total number may be a sum of the first number adjusted by a first weight and the second number adjusted by a second weight.

When the total number of pixels is greater than the predetermined threshold (YES, step 815), method 800 may include determining that an object is within the safety zone. When the total number of pixels is not greater than (e.g., smaller than or equal to) the predetermined threshold (NO, step 815), method 800 may include determining that an object is not within the safety zone (step 825).

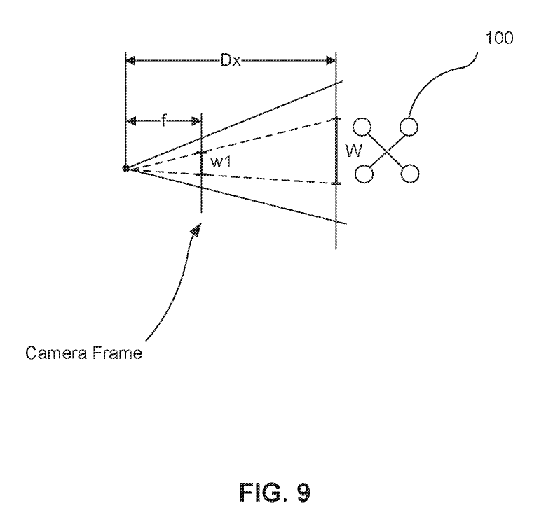

FIG. 9 schematically illustrates an exemplary method for projecting the flying tunnel and the crash tunnel onto a depth layer. As described above, the width of crash tunnel 710 may be the same as the width of movable object 100. Using the projection illustrated in FIG. 9, the width w1 and height h1 of crash tunnel 710 projected on a depth layer may be calculated from the following formulas:

$$\begin{matrix}w 1 = f \frac{W}{{D}_{x}} & ( 2 ) \\ h 1 = f \frac{H}{{D}_{x}} & ( 3 )\end{matrix}$$

In formulas (2) and (3), f is a focal length of a camera (e.g., camera 401), W is the width of movable object 100, His the height of movable object 100, and Dₓ is the depth associated with the depth layer in the x direction (e.g., the traveling direction of movable object 100). Dₓ may be the same depth of the pixels included in the depth layer, or the average depth of the pixels included in the depth layer.

The width w2 and height h2 of the projection of flying tunnel 705 on the depth layer may be calculated using the following formulas:

$$\begin{matrix}w 2 = f \frac{W}{{D}_{x}} + {δ}_{w} {v}_{x} & ( 4 ) \\ h 2 = f \frac{H}{{D}_{x}} + {δ}_{h} {v}_{x} & ( 5 )\end{matrix}$$

In formulas (4) and (5), δ_{w} and δₕ represent predetermined amounts added to the width and height of movable object 100, respectively. These amounts are adjusted by the speed vₓ, of movable object 100. The larger the speed vₓ, the greater the width w2 and height h2 of the projection of flying tunnel 705 on the depth layer.

Projecting flying tunnel 705 and crash tunnel 710 onto a depth layer (e.g., one of depth layers 515-530) may include determining a location of a center of a projection of the flying tunnel and/or the crash tunnel. The projections of flying tunnel 705 and crash funnel 710 may or may not be concentric.

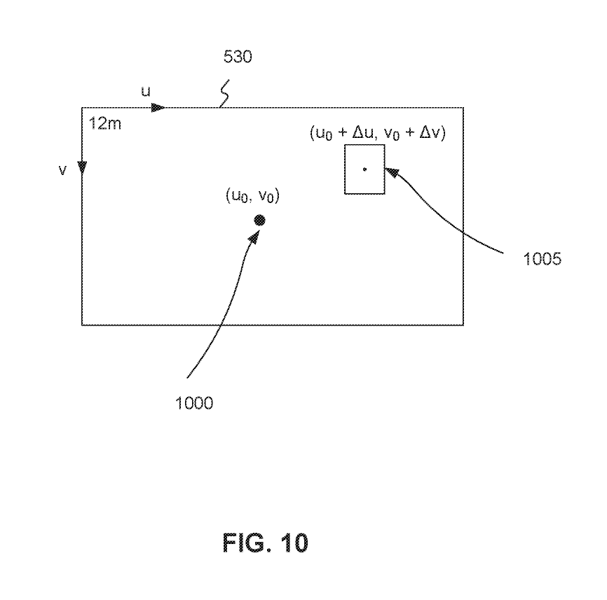

FIG. 10 schematically illustrates an exemplary method for determining a location of a flying tunnel and/or a crash tunnel projected onto a depth layer in the depth space associated with a certain depth. FIG. 10 shows depth layer 530, which may be associated with a depth of 12 meters. It is understood that similar calculations for the location of the projected tunnels may also be made with other depth layers (e.g., depth layers 515, 520, and 525).

FIG. 10 shows a coordinate system (u, v). The coordinate system may be associated with the image frame. An optical center 1000 of the image frame is located at (u0, v0) on depth layer 530. A tunnel projection 1005 may represent a projection of flying tunnel 705 and/or crash tunnel 710. A center of tunnel projection 1005 may be located at (u0+Δu, v0+Δv) on depth layer 530, where Δu and Δv represent offsets from the optical center 1000 in u and v directions.

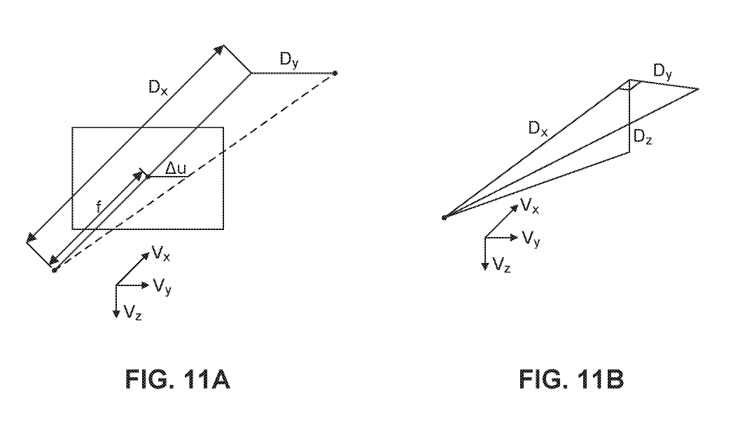

FIGS. 11A and 11B illustrate an exemplary method for determining the location of the center of the projection of the flying tunnel and/or the crash tunnel. The location of the center of the projection of the flying tunnel and/or crash tunnel on the depth layer may be determined based on the current velocity of movable object 100. Based on the geometric relationship shown in FIGS. 11A and 11B, the offsets Δu and Δv may be calculated using the following formulas:

$$\begin{matrix}\frac{{D}_{y}}{{D}_{x}} = \frac{\int {V}_{y} dt}{\int {V}_{x} dt} = \frac{{V}_{y} \cdot τ}{{V}_{x} \cdot τ} = \frac{{V}_{y}}{{V}_{x}} & ( 6 ) \\ \frac{{D}_{z}}{{D}_{x}} = \frac{\int {V}_{z} dt}{\int {V}_{x} dt} = \frac{{V}_{z} \cdot τ}{{V}_{x} \cdot τ} = \frac{{V}_{z}}{{V}_{x}} & ( 7 ) \\ Δ u = f \frac{{D}_{y}}{{D}_{x}} = f \frac{{V}_{y}}{{V}_{x}} & ( 8 ) \\ Δ v = f \frac{{D}_{z}}{{D}_{x}} = f \frac{{V}_{z}}{{V}_{x}} & ( 9 )\end{matrix}$$

FIGS. 11A and 11B schematically show the components of the current velocity V of movable object 100 in three directions, x, y, and z. Here, x direction is the same as the traveling direction of movable object 100, y direction is a direction perpendicular to the x direction on a horizontal plane, and z direction is a direction pointing to the ground and perpendicular to the x and y directions. Dₓ is a depth in the x direction, D_{y} is a depth in they direction, and D_{z} is a depth in the y direction. Vₓ is the x direction component of velocity V, V_{y} is the y direction component of velocity V, and V_{z} is the z direction component of velocity V.

For each depth layer, movable object 100 may determine whether an object is within the safety zone by counting the total number of pixels within the projection of the safety zone on the depth layer. For example, when the safety zone is defined by the flying tunnel and the crash tunnel, counting the number of pixels may include counting the number of pixels within projections of the flying tunnel and the crash tunnel. Different weights may be assigned to the numbers of pixels in the projections of the flying tunnel and crash tunnel. For example, pixels within the projection of the crash tunnel may be given more weight than pixels within the projection of the flying tunnel.

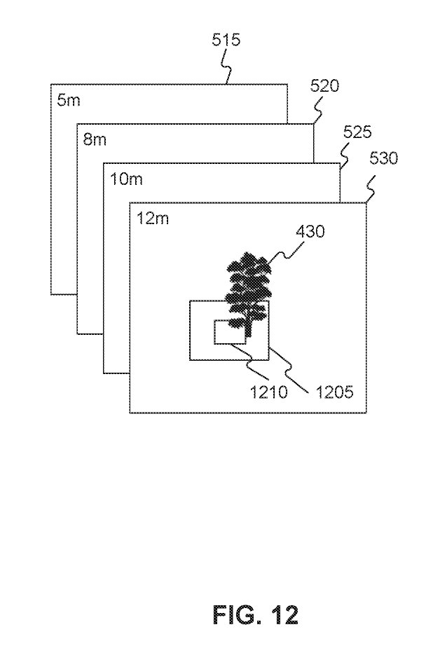

FIG. 12 illustrates an exemplary method for determining whether an object is within the safety zone of a movable object. After the flying tunnel and crash tunnel are projected onto a depth layer, and after the location and size of the projections of the flying tunnel and crash tunnel are determined, controller 130 may count, e.g., via processor 320, a number of pixels within the projections of the flying tunnel and crash tunnel on the depth layer.

FIG. 12 shows the plurality of depth layers 515-530. Controller 130 may determine whether an object is within the safety zone by first counting the pixels within the projection of the flying tunnel and crash tunnel on the closest depth layer, e.g., depth layer 515 associated with a depth of 5 meters. If an object is detected within the safety zone, the travel path may be adjusted to avoid the object. If an object is not detected within the safety zone, controller 130 may determine whether an object is within the safety zone by counting the pixels within the projections of the flying tunnel and the crash tunnel on the next closest depth layer, e.g., depth layer 520 that is associated with a depth of 8 meters. Similar process may be performed for other depth layers. For illustrative purposes, FIG. 12 uses depth layer 530 (associated with a depth of 12 meters) as an example to illustrate the method of object detection.

As shown in FIG. 12, depth layer 530 includes pixels of an object, e.g., third tree 430. Flying tunnel 705 and crash tunnel 710 are projected onto depth layer 530. Tunnel projection 1205 represents the projected flying tunnel 705 and tunnel projection 1210 represents the projected crash tunnel 710 on depth layer 530. Some pixels of third tree 430 are within the tunnel projections 1205 and 1210. Controller 130 may count, e.g., through processor 320 or impact estimating module 340, a number N_{fly} of pixels within tunnel projection 1205 (i.e., projection of flying tunnel 705) and a number of pixels N_{c} within tunnel projection 1210 (i.e., projection of crash tunnel 710). The total number of pixels may be calculated by:

N=N_{fly}*a1+N_{c}*a2 (10)

In formula (8), a1 and a2 are weights for pixels within the projections of the flying tunnel and crash tunnel, respectively. In some embodiments, the weights may be different for pixels within the flying tunnel and crash tunnel. For example, a1 may be 0.3, whereas a2 may be 0.7. In some embodiments, the weights may be the same. For example, a1=a2=1. In some embodiments, one of the weights may be zero, for example, when only one of flying tunnel 705 and crash tunnel 710 is projected onto depth layer 530.

Controller 130 may determine whether the total number of pixels within the safety zone is greater than a predetermined threshold, e.g., Ns. If N>Ns, controller 130 may determine that at least a portion of an object has been detected in the safety zone. For example, controller 130 may detect at least a portion of an object in crash tunnel 710, in flying tunnel 710, or in both flying tunnel 705 and crash tunnel 710.

When an object is detected within the safety zone of movable object 100, controller 130 may determine that the travel path should be adjusted to avoid the object (e.g., to travel around or circumvent the object). For example, obstacle avoidance module 350 and/or processor 320 included in controller 130 may perform various methods to adjust the travel path to avoid the object. When an object is not detected from a closest depth layer associated with a smallest depth, e.g., 3 meters, controller 130 may continue to detect an object on the next closest depth layer, e.g., a depth layer with a depth of 5 meter, 8 meters, 12 meters, and so on. For example, an object may be detected from depth layer 515 associated with a depth of 5 meters.

When an object is detected within the safety zone from depth layer 515 associated with a depth of 5 meters, controller 130 may control propulsion devices 105 to brake (e.g., reduce the speed of the movable object) according to a maximum braking speed corresponding to the depth of 5 meters. Different maximum braking speeds corresponding to different depths may be stored in a table or other forms in a database. The database may be stored in a memory (e.g., memory 310 or memory module 220). Controller 130 may look up the table to determine the maximum braking speed corresponding to the depth of the depth layer on which an object is detected within the safety zone. For example, the maximum braking speed may be 9.51 meter/second (m/s) corresponding to a depth of 5 meters. This maximum braking speed of 9.51 m/s may be implemented in a speed control system to reduce the speed of the movable object. In some embodiments, a speed that is smaller than the maximum braking speed of 9.51 m/s may be implemented in the speed control system, such as 8.5 m/s.

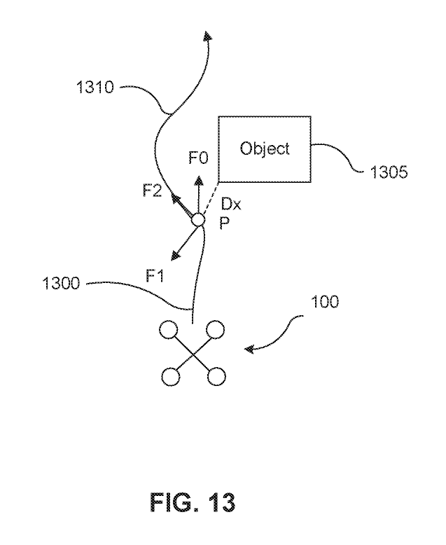

FIG. 13 illustrates an exemplary method for adjusting the travel path of a movable object to avoid a detected object. Movable object 100 travels along a travel path 1300 before an object is detected. When movable object 100 travels to a certain point, e.g., point P, along travel path 1300, movable object 100 detects an object 1305. Object 1305 may represent a regular object (i.e., not a large object that would occupy a large percentage of the image frame when movable object 100 is close to the object). Movable object 100 may adjust travel path 1300 to avoid object 1305. Adjusted travel path 1310 may include a portion that goes around object 1305.

In some embodiments, as shown in FIG. 13, when movable object 100 is near object 1305 (e.g., within a predetermined distance from object 1305), controller 1300 may emulate a repulsive field in adjusting travel path 1300 to avoid object 1305. For example, at point P, the propulsion field of movable object 100 generated by propulsion devices 105 may be designated as vector F0. A repulsive field (vector) F1 may be emulated and imposed on the propulsion filed F0. The resulting field from combining the propulsion field F0 and the repulsive field F1 may be designated as a new field (vector) F2. Each of the fields F0, F1, and F2 may include velocity and/or acceleration fields (vectors). The direction of the repulsive field F1 is away from the object (as if the object pushes movable object away). The magnitude of repulsive field F1 may be inversely proportional to the depth Dₓ of object 1305 in the captured image. The repulsive field F1 may be inversely proportional to any order of depth Dₓ, such as first order Dₓ, second order Dₓ², third order Dₓ³, etc.

An exemplary method to emulate the repulsive field (denoted as Fᵣₑₚᵤₗₛᵢᵥₑ in below formulas) can be derived from the theory of the gravitational force. From the well-known formula for the gravitational force:

$$F = G \frac{m 1 m 2}{{r}^{2}} \qquad ( 11 )$$

the repulsive force can be derived as:

$${F}_{repulsive} = G \frac{M 1 M 2}{{D}_{x}^{2}} \qquad ( 12 )$$

In formulas (11) and (12), G is a constant value, M₁ is the mass of movable object 100, and M₂ is the mass of detected object 1305. M₂ may be assigned a relatively large, constant value. Thus, G*M₂ may be replaced with a constant value k. The constant value k may be an empirical value that may be obtained through experiments. Then, the repulsive acceleration may be calculated using the following formula:

$${a}_{repulsive} = \frac{{F}_{repulsive}}{M 1} = \frac{k}{{D}_{x}^{2}} \qquad ( 13 )$$

From the following additional formulas:

S=∫V(t)dt (14)

V(t)=∫a(t)dt=a(t)t (15)

the repulsive velocity Vᵣₑₚᵤₗₛᵢᵥₑ may be calculated using the following formula:

Vᵣₑₚᵤₗₛᵢᵥₑ=\sqrt{2k/Dₓ} (16)

The repulsive acceleration aᵣₑₚᵤₗₛᵢᵥₑ and the repulsive velocity Vᵣₑₚᵤₗₛᵢᵥₑ may be imposed onto the current acceleration and velocity of movable object 100. As a result of combining these accelerations and velocities, the velocity and acceleration of movable object 100 is changed, thereby altering the travel path.

In some embodiments, after an object is detected in the safety zone and identified as an obstacle, when movable object 100 is far away from the object (e.g., greater than a predetermined distance to the object), the movable object may first brake using the maximum braking speed corresponding to the depth of the depth layer in which the object is detected. Braking movable object 100 may not cause an adjustment to the travel path of movable object 100. When movable object 100 is near the object (e.g., within the predetermined distance to the object), movable object 100 may then implement the repulsive field methods described above to adjust the travel path to avoid the object.

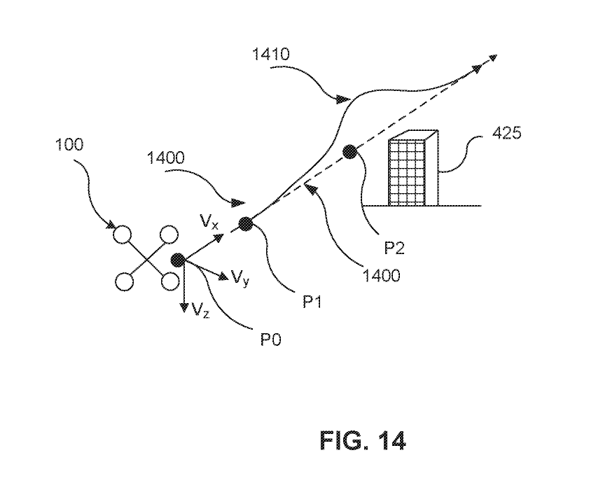

FIG. 14 schematically illustrates an exemplary method for adjusting the travel path of a movable object when a large object is detected within the safety zone. As described above, a large object differs from a regular object in that a large object may occupy a large percentage (e.g., 60%, 70%, 80%, 90%, 100%) of the image frame when the movable object is too close to the large object. When the movable object is too close to the large object, the movable object may have difficulty in finding a way around the large object based on image analysis, because a large percentage of the image frame is occupied by the large object. Therefore, methods for adjusting the travel path when a large object is detected may be different from methods described above in connection with FIG. 13 when a regular object is detected.

As movable object 100 moves along a travel path 1400, at point P0, movable object 100 detects a large object (e.g., building 425). At point P0, controller 130 may determine, e.g., based on analysis of images showing building 425 and the current speed of movable object 100, that building 425 would occupy 90% of the image frame in 5 minute. Assuming movable object 100 will move to point P2 in 5 minute. Controller 130 may adjust the travel path before movable object 100 reaches point P2. For example, when reaching point P1 (a point on travel path 1400 before closer to the current position of movable object 100 than point P2), controller 130 may adjust travel path 1400 and generate a new travel path 1410, such that movable object 100 travels along new travel path 1410 starting from point P1. The new travel path 1410 goes around building 425, and does not include point P2. Any suitable methods may be used to generate the adjusted travel path 1410 that goes around building 425.

In some embodiments, after the large object is detected in the safety zone, when movable object 100 is still far away from the large object, movable object 100 may first brake using the maximum braking speed corresponding to the depth of the depth layer in which the object is detected. Braking the movable object may not cause an adjustment to the travel path of movable object 100. When movable object 100 approaches point P1, movable object 100 may then adjust the travel path such that the adjusted travel path avoids the large object so that movable object 100 would not move too close to the large object, which may occupy a large percentage of the image frame of movable object 100, making it difficult to find a way around the large object.

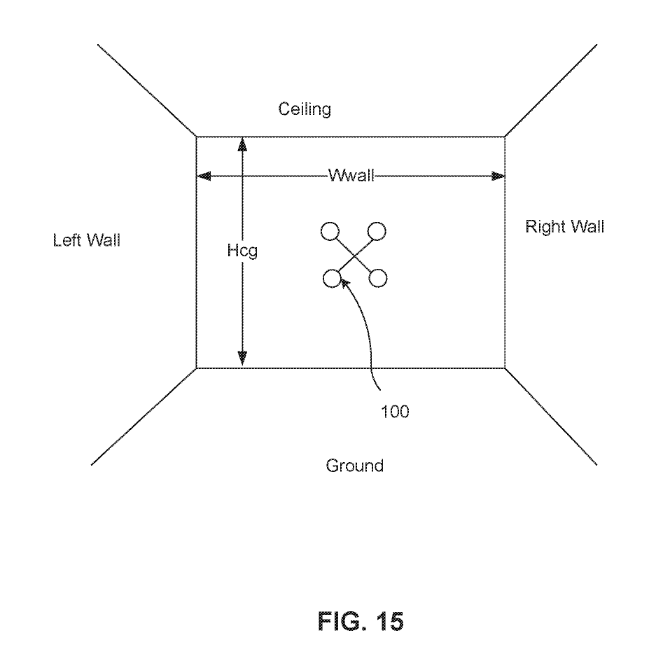

When the movable object is moving in an environment with barriers such as walls, floor, and ceiling, the movable object may falsely identify such barriers as obstacles, even though it is moving in parallel with the barriers and would not crash into them. FIGS. 15-17 illustrate a situation where a movable object is moving in an enclosed environment with a ceiling, a floor (or ground), a left wall, and a right wall. Through various sensors (e.g., radar sensor, laser sensor, ultrasonic sensor, image sensor), movable object 100 may measure the distances from the ceiling, the ground, the left wall, and the right wall. Assuming, as shown in FIG. 15, floor-to-ceiling height is H_{cg} and the distance from the left wall to the right wall W_{wall}, movable object 100 may define a cage tunnel as having width W_{wall} and H_{cg}. Following the same projection method described above, and by replacing W with W_{wall} and H with H_{cg} in formulas (2)-(5), the cage tunnel may be projected onto different depth layers associated with different depths. The size and location of the projection of the cage tunnel on the different depth layers may be calculated using formulas (2)-(5).

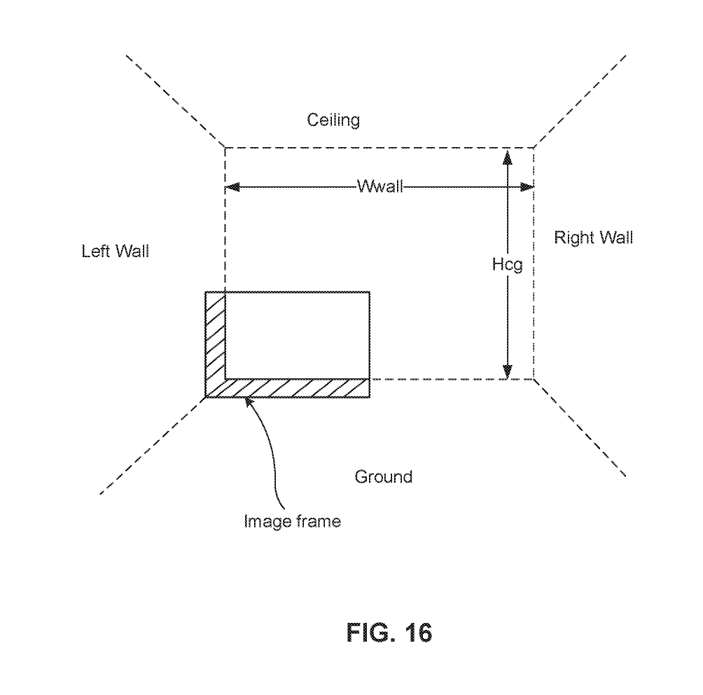

FIG. 16 schematically illustrates the cage tunnel as projected onto a depth layer. As shown in FIG. 16, the camera on movable object 100 may capture an image of the indoor environment within the image frame. The cage tunnel having the left wall, right wall, ground, and ceiling, when projected onto a depth layer, may have only a portion of the left wall and a portion of the ground on the depth layer, with the rest of the cage tunnel (shown in dotted lines) out of the image frame (hence not appearing on the depth layer).

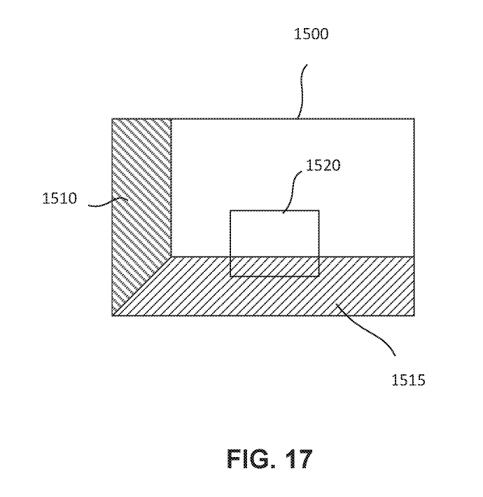

FIG. 17 illustrates a result of projecting the cage tunnel and flying tunnel 705 onto a depth layer 1500 having a certain depth (e.g., 12 meters) using the projection method described above. A portion of wall 1510 and a portion of ground 1515 are shown on depth layer 1500 with their pixels having a depth of 12 meters. Flying tunnel 705 is projected onto depth layer 1500 as a projection 1520. Projection 1520 of flying tunnel 705 may overlap with the portion of wall 1510, the portion of ground 1515, or both. FIG. 17 shows that projection 1520 of flying tunnel 705 overlaps the portion of ground 1515. In other words, some pixels of the ground 1515 are within projection 1520 of flying tunnel 705. When applying the above described methods for counting pixels within the projection of flying tunnel 705 to determine whether an object is an obstacle, the pixels of ground 1515 within projection 1520 of flying tunnel 705 will not be counted (i.e., they will be excluded). In other words, although there are pixels within projection 1520 of flying tunnel 705, controller 130 does not treat those pixels as pixels of an obstacle that would require adjustment of the travel path. Although only a projection 1520 of flying tunnel 705 is shown in FIG. 17, it is understood that crash tunnel 710 may also be projected onto depth layer 1500. The method described above for counting pixels within both the crash tunnel and the flying tunnel are projected onto a depth layer may be implemented. For the purpose of determining whether an object is an obstacle, any pixels of the wall and/or ground within the projection of crash tunnel 710 will be excluded from the total number of pixels.

When a wall and/or ground is identified in a depth layer, controller 130 may not cause movable object 100 to stop moving. Instead, controller 130 may allow movable object 100 to move in parallel (or substantially in parallel) with the ground and/or wall while maintaining a safe predetermined distance from the ground and/or wall.

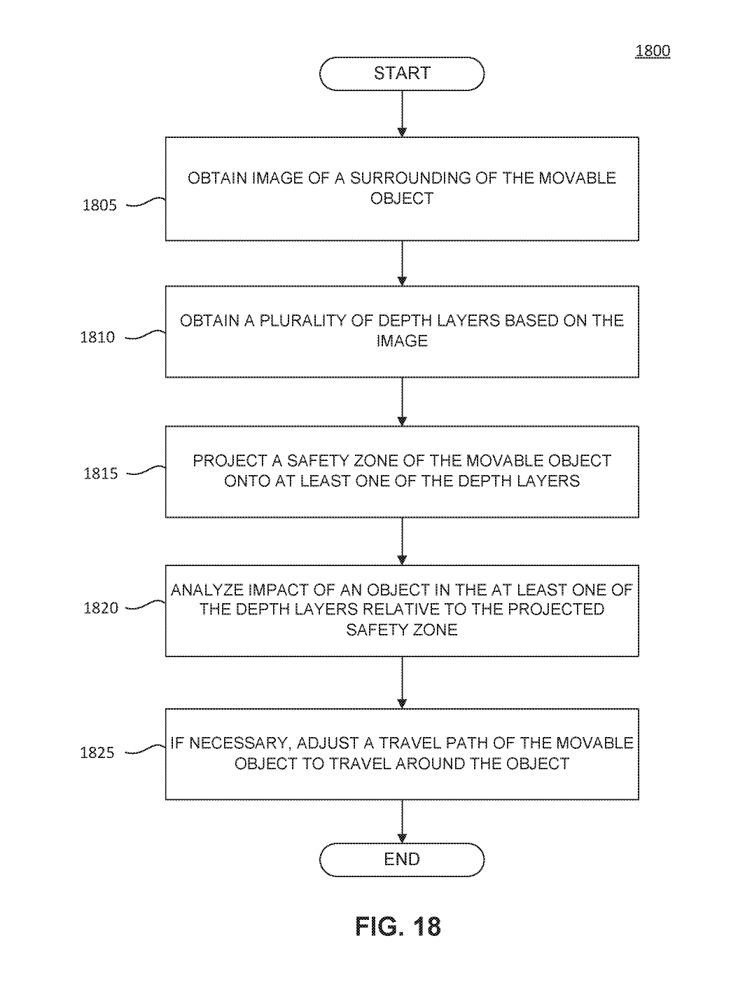

FIG. 18 is a flowchart illustrating an exemplary method for a movable object. Method 1800 may be performed by movable object 100. For example, method 1800 may be performed by various processors, modules, devices, and sensors provided on or external to movable object 100. In one embodiment, method 1800 may be performed by controller 130 (e.g., processor 320) included in movable object 100.

Method 1800 may include obtaining an image of a surrounding of the movable object (step 1805). For example, an image sensor included in imaging system 125 may capture an image of a surrounding of the movable object as the movable object moves within an environment. Method 1800 may include obtaining a plurality of depth layers based on the image (step 1810). As described above, obtaining the plurality of depth layers may include processing the image to obtain a depth map and obtaining depth information of pixels of the image based on the depth map. Controller 130 may generate the plurality of depth layers, each depth layer including pixels having the same depth or having depths within a predetermined range.

Method 1800 may include projecting a safety zone of the movable object onto at least one of the depth layers (step 1815). As described above, the safety zone may include a flying tunnel and a crash tunnel. Detailed method of projecting the flying tunnel and the crash tunnel has been described above.

Method 1800 may also include analyzing impact of an object in the at least one of the depth layers relative to the projected safety zone (step 1820). Analyzing the impact may include determining whether an object is an obstacle based on a position of the object on the at least one of the depth layers relative to the projected safety zone. In some embodiments, determining whether the object is an obstacle includes counting a total number of pixels of the object within the projected safety zone (e.g., projected flying tunnel and crash tunnel), as described above. When the total number of pixels is greater than a predetermined threshold, controller 130 may determine that the object is an obstacle.

If necessary, method 1800 may also include adjusting a travel path of the movable object to travel around the object (step 1825). For example, when controller 130 determines that the object is an obstacle, controller 130 may adjust the travel path to travel around the object. Various methods described above may be used to adjust the travel path in order to avoid (e.g., by traveling around) the object. Method 1800 may include other steps and processes described above in connection with other figures or embodiments, which are not repeated.

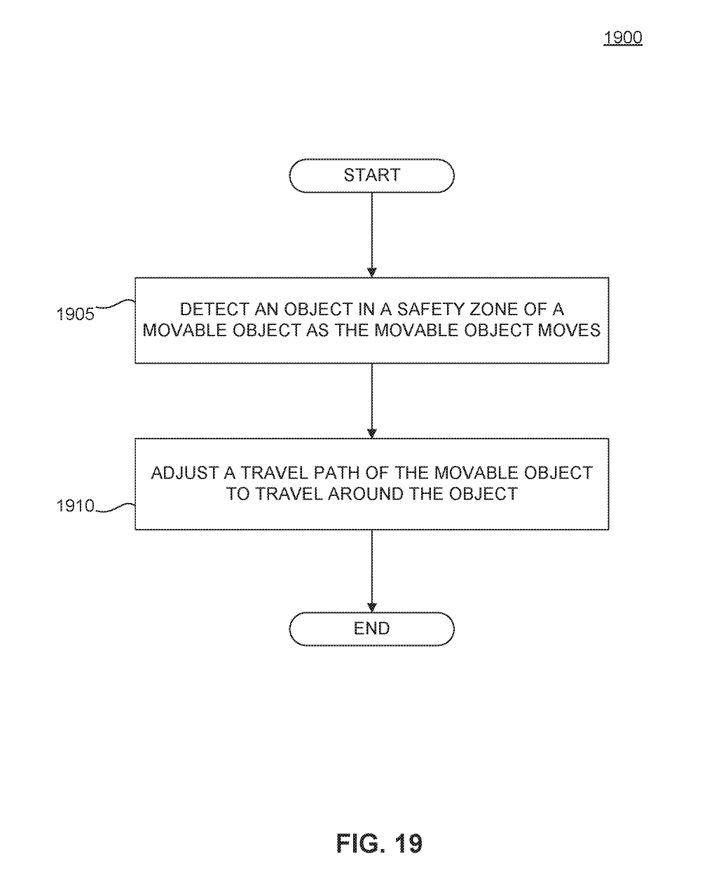

FIG. 19 is a flowchart illustrating an exemplary method for a movable object. Method 1800 may be performed by movable object 100. For example, method 1900 may be performed by various processors, modules, devices, and sensors provided on or external to movable object 100. In one embodiment, method 1900 may be performed by controller 130 (e.g., processor 320) included in movable object 100. Method 1900 may include detecting an object in a safety zone of a movable object as the movable object moves (step 1905). Detailed methods for detecting the object have been described above. Method 1900 may also include adjusting a travel path of the movable object to travel around the object (step 1910). Various methods described above may be used to adjust the travel path of the movable object. Method 1900 may include other steps and processes described above in connection with other figures or embodiments, which are not repeated.

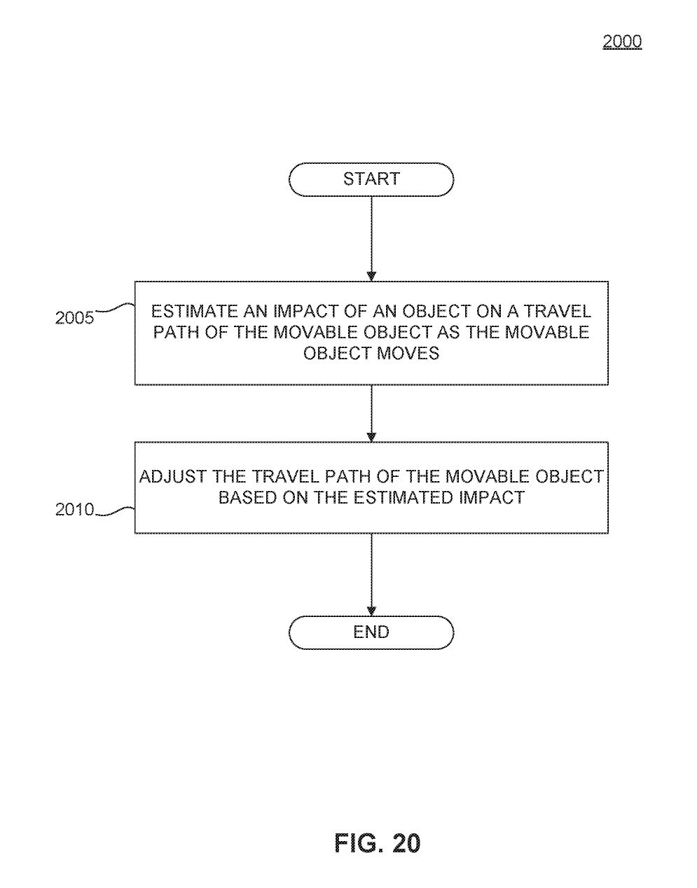

FIG. 20 is a flowchart illustrating another exemplary method for a movable object. Method 2000 may be performed by movable object 100. For example, method 2000 may be performed by various processors, modules, devices, and sensors provided on or external to movable object 100. In one embodiment, method 2000 may be performed by controller 130 (e.g., processor 320) included in movable object 100. Method 2000 may include estimating an impact of an object on a travel path of the movable object as the movable object moves (step 2005). Estimating the impact of an object may include detecting the object on the travel path, such as detecting the object in a safety zone of movable object, as described above. Detecting the object may use any method described above.

Method 2000 may also include adjusting the travel path of the movable object based on the estimated impact (step 2010). Methods for adjusting the travel path may depend on whether the object is a large object or regular object. The methods described above for adjusting the travel path when a regular object is detected and when a large object is detected may be used in step 2010. Method 2000 may include other steps or processes described above in connection with other figures or embodiments, which are not repeated.

The technologies described herein have many advantages in the field of object detection and obstacle avoidance for movable objects. For example, detecting object may be automatically performed by the movable object as the movable object moves. When the object is detected within a safety zone of the movable object, the movable object may adjust the travel path to include a smooth path around the detected object without an abrupt change in the travel path. Accurate detection and smooth obstacle avoidance may be achieved with the disclosed systems and methods. In addition, when a user operates the movable object along a travel path, the movable object automatically adjusts the travel path based on detection of an object to avoid the object. The disclosed systems and methods provide enhanced user experience.

Disclosed embodiments may implement computer-executable instructions, such as those included in program modules and executed in a computing environment on a physical or virtual processor device. Program modules may include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed a processing unit, as described above.

Various operations or functions of the example embodiments can be implemented as software code or instructions. Such content can be directly executable (e.g., in “object” or “executable” form), source code, or difference code (e.g., “delta” or “patch” code). Software implementations of the embodiments described herein can be provided via an article of manufacture with the code or instructions stored thereon, or via a method of operating a communication interface to transmit data via the communication interface. A machine or computer-readable storage device can cause a machine to perform the functions or operations described. The machine or computer-readable storage device includes any mechanism that stores information in a tangible form accessible by a machine (e.g., computing device, electronic system, and the like), such as recordable/non-recordable media (e.g., read only memory (ROM), random access memory (RAM), magnetic disk storage media, optical storage media, flash memory devices, and the like). Computer-readable storage devices store computer-readable instruction in a non-transitory manner and do not include signals per se.

Aspects of the embodiments and any of the methods described herein can be performed by executing computer-executable instructions stored in one or more computer-readable media or devices, as described herein. The computer-executable instructions can be organized into one or more computer-executable components or modules. Aspects of the embodiments can be implemented with any number of such components or modules. For example, aspects of the disclosed embodiments are not limited to the specific computer-executable instructions or the specific components or modules illustrated in the figures and described herein. Other embodiments may include different computer-executable instructions or components having more or less functionality than illustrated and described herein.

The order of execution or performance of the methods in the disclosed embodiments is not essential, unless otherwise specified. That is, the methods can be performed in any order, unless otherwise specified, and embodiments can include additional or fewer methods than those disclosed herein. For example, it is contemplated that executing or performing a particular method step before, contemporaneously with, or after another method step is within the scope of aspects of the disclosed embodiments.

Having described the disclosed embodiments in detail, it will be apparent that modifications and variations are possible without departing from the scope of aspects as defined in the appended claims. For instance, elements of the illustrated embodiments may be implemented in software and/or hardware. In addition, the technologies from any embodiment or example can be combined with the technologies described in any one or more of the other embodiments or examples. In view of the many possible embodiments to which the principles of the disclosed technology may be applied, it should be recognized that the illustrated embodiments are examples of the disclosed technology and should not be taken as a limitation on the scope of the disclosed technology. Therefore, it is intended that all matter contained in the above description and shown in the accompanying drawings shall be interpreted as illustrative and not in a limiting sense.

What is claimed is:

1. A method of controlling a movable object, comprising:
obtaining an image of a surrounding of the movable object;
obtaining a plurality of depth layers based on the image;
projecting a safety zone of the movable object onto at least one of the depth layers;
determining whether an object is an obstacle based on a position of the object on the at least one of the depth layers relative to the projected safety zone; and
adjusting a travel path of the movable object to travel around the obstacle.

2. The method of claim 1, further comprising determining a size of the safety zone based on a size of the movable object and a current velocity of the movable object.

3. The method of claim 1,
wherein the safety zone includes at least one of a flying tunnel or a crash tunnel, and
wherein determining whether the object is the obstacle includes analyzing the position of the object with the at least one of the flying tunnel or the crash tunnel as projected onto the at least one of the depth layers.

4. The method of claim 3, further comprising obtaining depth information of pixels of the image.

5. The method of claim 4, wherein obtaining the plurality of depth layers includes generating the depth layers based on the depth information of the pixels, each depth layer including pixels having a predetermined depth or a predetermined range of depth.

6. The method of claim 5, further comprising projecting the at least one of the flying tunnel or the crash tunnel onto the at least one of the depth layers.

7. The method of claim 6, wherein determining whether the object is the obstacle based on the position of the object on the at least one of the depth layers relative to the projected safety zone includes counting a total number of pixels of the object within a projection of the at least one of the flying tunnel or the crash tunnel on the at least one of the depth layers.

8. The method of claim 7, wherein counting the total number of pixels includes using a first weight to adjust a first number of pixels in a projection of the flying tunnel on the at least one of the depth layers and a second weight to adjust a second number of pixels in a projection of the crash tunnel on the at least one of the depth layers.

9. The method of claim 7, further comprising:
detecting at least one of ground or a wall within the projection of the at least one of the flying tunnel or the crash tunnel,
wherein counting the total number of pixels includes excluding the pixels of the at least one of the ground or the wall within the projection of the at least one of the flying tunnel or the crash tunnel.

10. The method of claim 1, wherein adjusting the travel path includes imposing a repulsive field onto at least one of a velocity field or an acceleration field of the movable object when the movable object is within a predetermined distance to the object.

11. The method of claim 1, wherein determining whether the object is the obstacle includes determining that the object is a large object by determining that the object will occupy a predetermined percentage of an image frame in an amount of travel time, and
wherein adjusting the travel path includes adjusting the travel path to avoid getting too close to the object before the object occupies the predetermined percentage of the image frame.

12. A system for a movable object, comprising:
a controller including one or more processors configured to:
obtain an image of a surrounding of the movable object;
obtain a plurality of depth layers based on the image;
project a safety zone of the movable object onto at least one of the depth layers;
determine whether an object is an obstacle based on a position of the object on the at least one of the depth layers relative to the projected safety zone; and
adjust a travel path of the movable object to travel around the obstacle.

13. The system of claim 12,
wherein the safety zone includes at least one of a flying tunnel or a crash tunnel, and
wherein determining whether the object is the obstacle includes analyzing the position of the object with the at least one of the flying tunnel or the crash tunnel as projected onto the at least one of the depth layers.

14. The system of claim 13, wherein the one or more processors are further configured to obtain depth information of pixels of the image.

15. The system of claim 14, wherein obtaining the plurality of depth layers includes generating the depth layers based on the depth information of the pixels, each depth layer including pixels having a predetermined depth or a predetermined range of depth.

16. The system of claim 15, wherein the one or more processors are further configured to project the at least one of the flying tunnel or the crash tunnel onto the at least one of the depth layers.

17. The system of claim 16, wherein determining whether the object is the obstacle based on the position of the object on the at least one of the depth layers relative to the projected safety zone includes counting a total number of pixels of the object within a projection of the at least one of the flying tunnel or the crash tunnel.

18. The system of claim 16, wherein the one or more processors are further configured to determine that at least a portion of the object is within the safety zone when the total number of pixels is greater than a predetermined threshold.

19. The system of claim 12, wherein determining whether the object is the obstacle includes determining that the object is a large object by determining that the object will occupy a predetermined percentage of an image frame in an amount of travel time, and
wherein adjusting the travel path includes adjusting the travel path to avoid getting too close to the object before the object occupies the predetermined percentage of the image frame.

20. An unmanned aerial vehicle (UAV) system, comprising:
one or more propulsion devices; and
a controller in communication with the one or more propulsion devices and including one or more processors configured to:
obtain an image of a surrounding of the UAV;
obtain a plurality of depth layers based on the image;
project a safety zone of the UAV onto at least one of the depth layers;
determine whether an object is an obstacle based on a position of the object on the at least one of the depth layers relative to the projected safety zone; and
adjust a travel path of the UAV to travel around the obstacle.
